(19) United States
(12) Patent Application Publication
(10) Pub. No.: US 2008/0005086 A1
(43) Pub. Date: Jan. 3, 2008

(54) CERTIFICATE-BASED SEARCH

(76) Inventor: James F. Moore, Lincoln, MA (US)

Correspondence Address: STRATEGIC PATENTS P.C.., C/O PORTFOLIOIP, P.O. BOX 52050, MINNEAPOLIS, MN, 55402, US

(21) Appl. No.: 11/750,301

(22) Filed: May 17, 2007

Related U.S. Application Data
(60) Provisional application No. 60/747,425, filed on May 17, 2006.

(51) Int. Cl. G06F 17/30; H04L 9/00

(52) U.S. Cl. 707/3; 713/156

(57) ABSTRACT

The systems and methods disclosed herein provide for authentication of content sources and/or metadata sources so that downstream users of syndicated content can rely on these attributes when searching, citing, and/or redistributing content. To further improve the granularity and reusability of content, globally unique identifiers may be assigned to fragments of each document. This may be particularly useful for indexing documents that contain XML grammar with functional aspects, where atomic functional components can be individually indexed and referenced independent from a document in which they are contained.

### RELATED APPLICATIONS

This application claims the benefit of U.S. App. No. 60/747,425 filed on May 17, 2006, the entire content of which is incorporated herein by reference.

### BACKGROUND

1. Field of Invention

The invention relates to certificate-based searching for distributed data such as syndicated content, and outlined content, and other web-based content.

2. Related Art

Internet search has attracted significant activity aimed at improving the speed, scope, and relevance of search results. Highly successful companies have also leveraged popular search engines into related areas such as targeted advertising, specialty searches, and the like. Beneath these web-based or programming-interface-based search systems lay sophisticated technologies for locating content, indexing content, and determining the relevance of content in response to particular search requests. While these systems do well at finding responsive content among the billions of web pages and other content items on the World Wide Web, they generally do not explicitly discriminate among content sources unless paid to do so by advertisers. Where syndicated content such as RSS items have become an increasingly popular medium for exchanging views and content on the Internet, there is a growing need for search systems sensitive to content sources, metadata sources, and distribution channels.

### SUMMARY OF THE INVENTION

The systems and methods disclosed herein provide for authentication of content sources and/or metadata sources so that downstream users of syndicated content can rely on these attributes when searching, citing, and/or redistributing content. To further improve the granularity and reusability of content, globally unique identifiers may be assigned to fragments of each document. This may be particularly useful for indexing documents that contain XML grammar with functional aspects, where atomic functional components can be individually indexed and referenced independent from a document in which they are contained.

Disclosed herein are techniques for combining certificates and certificate authorities with centralized and/or distributed search engines to improve aspects of electronic search such as speed, consistency, and reliability.

A method disclosed herein includes retrieving a document from a remote network location, the remote network location may be identified by a path; extracting a fragment from the document; assigning a globally unique identifier to the fragment; and storing the path, the fragment, and the globally unique identifier in a searchable database.

The document may be an outline document. The fragment may be an element of the outline document. The document may be a syndicated document. The fragment may be an item of the syndicated document. The document may be an XML document. The fragment may be a line of the document. The fragment may be an item within the document, the item delimited within the document by one or more tags. The one or more tags specify one or more attributes of the item. The fragment may be a metadata tag. The method and computer program product may further include determining a description of the fragment and associating the description with the globally unique identifier. The method may further include certifying the globally unique identifier. The method may further include forming a composite document from a plurality of globally unique identifiers. The method may further include parsing the composite document by applying one of the plurality of globally unique identifiers to the database to retrieve a corresponding path and retrieving a corresponding fragment from a corresponding remote network location specified by the corresponding path. The fragment may have been indexed in the searchable database and conditionally assigning the globally unique identifier only when the fragment has not been indexed. The fragment may have been indexed, identifying the fragment in the document as a new instance of the fragment identified by the globally unique identifier.

A method disclosed herein includes locating an item of content on a network, the item may have a path that identifies a location of the item on the network; determining an attribute of the item, the attribute may have an attribute type; creating a public key and a private key for the attribute type; creating a certificate comprising at least the public key, the attribute type, the attribute and a digital signature created using the private key; storing the certificate, the attribute, and at least a portion of the item in a database; and providing a web-accessible search engine for searching the database, the web-accessible search engine may permit searching according to the attribute.

The attribute type may be a time that the item was located. The attribute type may be a source of the item. The source may include one or more of a domain, a corporate entity, an organization, and an author. The attribute may include confirming the path and using the path as the attribute. The web-accessible search engine may rank search results according to the attribute. The method may further include authenticating the attribute by applying the public key to the digital signature.

A method disclosed herein includes creating a public and a private key for a content source; securely communicating the private key to the content source; retrieving an item of content from the content source; verifying the content source with the public key; and indexing the item in a database along with an entry indicating a verification of the content source; and providing a web-accessible search engine for searching the database, the web-accessible search engine may permit searching according to the content source.

Verifying the content source may include decrypting a certificate associated with the item. Verifying the content source may include decrypting the item. The content source may be a corporate entity. The content source may be an author. The content source may be a news media source. Retrieving the item may include locating the item with a spider. The item may be an RSS item. The item may be an OPML outline. Retrieving the item of content may include retrieving the item indirectly through a syndication channel and identifying the content source by inspecting metadata for the item of content.

A method disclosed herein includes retrieving an item of content from a network; encrypting the item; indexing the item in a database; distributing keys to a plurality of users; and providing a web-accessible search engine for the database, the search engine may authenticate a user for each search request according to the keys.

The method may further include providing unauthenticated access to a portion of the database. The method may further include providing role-based access to the plurality of users. At least one role may read all the database locations. At least one role may write to at least one database location. At least one role may control a programmable spider that searches the network for content. At least one role may have conditional access according to semantic content. At least one of the plurality of users may be a spider having write access to the database.

A method disclosed herein includes retrieving an item of content from a content source; retrieving a public key of the content source; verifying the content source with the public key; indexing the item in a database along with an entry indicating a verification of the content source; and providing a web-accessible search engine for searching the database, the web-accessible search engine may permit searching according to the content source.

Verifying the content source may include decrypting a certificate associated with the item. Verifying the content source may include decrypting the item. The content source may be a corporate entity. The content source may be a news media source. The content source may be an author. Retrieving the item may include locating the item with a spider. The item may be an RSS item. The item may be an OPML outline. Retrieving the item of content may include retrieving the item indirectly through a syndication channel and identifying the content source by inspecting metadata for the item of content.

A method disclosed herein includes locating one or more documents on a network; indexing the one or more documents in a database; authenticating a source for each of the one or more documents thereby providing an authentication status; and providing a web interface for searching the database, the web interface may be adapted to rank search results according to the authentication status.

The method may be further adapted to filter search results to remove any of the one or more documents for which the authentication status may be unauthenticated. The authentication status may include one or more of unauthenticated, authenticated by the content source, authenticated by the search engine, and authenticated by a trusted third party. The source may include one or more of an author, a news media source, and a publisher. The source may include a corporate entity.

A method disclosed herein includes locating a document on a network, the document may include a metadata attribute delimited by one or more tags; indexing the document in a database; determining a source of the metadata attribute; authenticating the source thereby providing an authentication status; and providing a web interface for searching the database, the web interface may be adapted to rank search results according to the authentication status.

Authenticating the source may include processing a certificate associated with the metadata attribute. The certificate may be provided by the source. The certificate may be provided by a trusted intermediary that authenticated the source. Authenticating the source may include requesting authentication from a trusted third party. Authenticating the source may include requesting authentication from the source. Authenticating the source may include requesting authentication from a trusted intermediary that has authenticated the source. The source may include a publisher. The source may include an author. The source may include a syndication feed. The source may include an aggregator. The source may include a syndication feed that republished the document from another source. The source may include a plurality of entities in a distribution channel. The metadata attribute may include one or more of a preference, a content description, a ranking, a relevance, a keyword, an author, a publisher, a related concept, an approval, a disapproval, a popularity, a number of views, a number of links, and a message type. The metadata attribute may include an objective metric. The metadata attribute may include a subjective metric. The metadata attribute may include a computer-generated attribute for the document. The metadata attribute may include a human-generated attribute for the document. The metadata attribute may include a human-selected attribute for the document.

Further disclosed herein are computer program products including computer executable code that, when executing on one or more computing devices, performs the steps of the methods detailed above.

The terms “feed”, “data feed”, “data stream” and the like, as well as the S-definition described further herein, as used herein, are intended to refer interchangeably to syndicated data feeds and/or descriptions of such feeds. While RSS is one popular example of a syndicated data feed, any other source of news or other items may be used with the systems described herein, such as the outlining markup language, OPML, or any other suitable XML grammar, and these terms should be given the broadest possible meaning unless a narrow sense is explicitly provided or clear from the context. Similarly, terms such as “item”, “news item”, and “post”, as well as the S-messages described further herein, are intended to refer to items within a data feed, and may contain text and/or binary data encoding any digital media including still or moving images, audio, application-specific file formats, and so on.

The term “syndication” is intended to refer to publication, republication, or other distribution of content using any suitable technology, including RSS and any extensions or modifications thereto, as well as any other publish-subscribe or similar technology that may be suitably adapted to the methods and systems described herein. “Syndicated” is intended to describe content in syndication.

The term “outline” is intended to refer to a document setting forth items, both within the document and, by external reference, outside the document, in hierarchical format. Items may include additional outline documents, hierarchical description, and, as described in greater detail herein, functional language. Items may also include other documents including without limitation application-specific file formats, audio media, visual media, audio-visual media, and so forth. OPML provides one suitable XML grammar for expressing outlines and hierarchical relationships, however, it will be understood that any other suitable grammar or document type may be employed to express and/or encapsulate outlines and outline subject matter. It will be understood that, while syndication and outlining are generally viewed as discrete technologies, it is entirely consistent with the systems and methods disclosed herein to have outlines that are syndicated and to have syndicated content that is outlined.

### BRIEF DESCRIPTION OF THE FIGURES

The foregoing and other objects and advantages of the invention will be appreciated more fully from the following further description thereof, with reference to the accompanying drawings, wherein:

FIG. 1 shows a network that may be used with the systems described herein.

FIG. 2 shows a system for using and aggregating data feeds.

FIG. 3 depicts a conceptual framework for syndicated communications.

FIG. 4 shows an XML environment for syndication systems.

FIG. 5 shows a user interface for a syndication system.

FIG. 6 shows a user interface for a syndication system.

FIG. 7 shows a process for certificate-based search.

### DETAILED DESCRIPTION

Various embodiments of the present invention are described below, including certain embodiments relating particularly to RSS feeds, OPML outlines, and other syndicated or outlined XML content. It should be appreciated, however, that the present invention is not limited to any particular protocol for data feeds or outlines and that the various embodiments discussed explicitly herein are primarily for purposes of illustration. Thus, the term syndication generally, and references to RSS specifically, should be understood to include, for example, RDF, RSS v 0.90, 0.91, 0.9x, 1.0, and 2.0, variously attributable to Netscape, UserLand Software, and other individuals and organizations, as well as Atom from the AtomEnabled Alliance, and any other similar formats, as well as non-conventional syndication formats that can be adapted for syndication, such as OPML. Still more generally, while RSS technology is described, and RSS terminology is used extensively throughout, it will be appreciated that the various concepts discussed herein may be usefully employed in a variety of other contexts. For example, various encryption, certification, and digital signature techniques described herein can be usefully combined with HTML Web content rather than RSS-based or OPML-based XML data to provide certificate-based search and ranking of Web content using authenticated metadata. Thus, it will be understood that the embodiments described herein are provided by way of example only and are not intended to limit the scope of the inventive concepts disclosed herein.

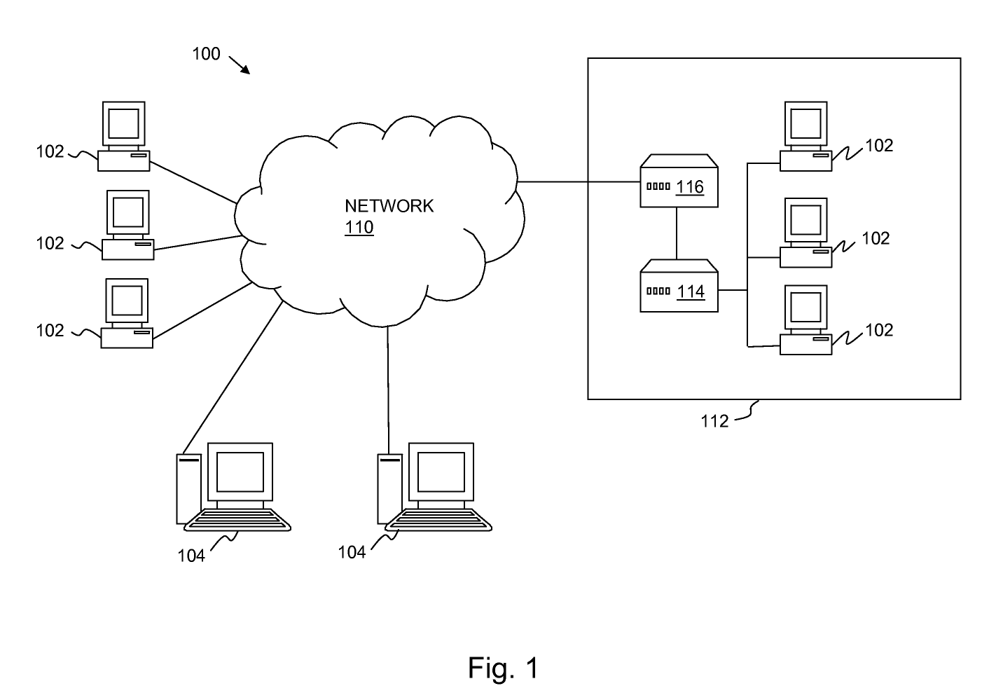

FIG. 1 shows a network for providing a syndicated data stream such as an RSS stream. Short for Really Simple Syndication, RDF (Resource Description Framework) Site Summary or Rich Site Summary, RSS is an XML format for syndicating Web content. A Web site operator who wants to allow other sites to publish some of the Web site's content may create an RSS document and register the document with an RSS publisher. The published or “syndicated” content can then be presented on a different site, or through an aggregator or other system, directly at a client device. Syndicated content may include such data as news feeds, events listings, news stories, headlines, project updates, excerpts from discussion forums, corporate information, advertisements, and so forth. While RSS content often includes text, other data may also be syndicated, typically in binary form, such as images, audio, and so forth. The systems described herein may use all such forms of data feed. In one embodiment, the XML/RSS feed itself may be converted to binary in order to conserve communications bandwidth. This may employ, for example, Microsoft's DINE specification for binary information or any other suitable binary format.

As shown in FIG. 1, a network 100 may include a plurality of clients 102 and servers 104 connected via an internetwork 110. Any number of clients 102 and servers 104 may participate in such a system 100. The system may further include one or more local area networks (“LAN”) 112 interconnecting clients 102 through a hub 114 (in, for example, a peer network such as a wired or wireless Ethernet network) or a local area network server 114 (in, for example, a client-server network). The LAN 112 may be connected to the internetwork 110 through a gateway 116, which provides security to the LAN 112 and ensures operating compatibility between the LAN 112 and the internetwork 110. Any data network may be used as the internetwork 110 and the LAN 112.

In one aspect of the systems described herein, a device within the internetwork 110 such as a router or, on an enterprise level, a gateway or other network edge or switching device, may cache popular data feeds to reduce redundant traffic through the internetwork 110. In other network enhancements, clients 102 may be enlisted to coordinate sharing of data feeds using techniques such as those employed in a BitTorrent peer-to-peer network. In the systems described herein, these and other techniques generally may be employed to improve performance of an RSS or other data feed network.

In one embodiment, the internetwork 110 is the Internet, and the World Wide Web provides a system for interconnecting clients 102 and servers 104 in a communicating relationship through the Internet 110. The internetwork 110 may also, or instead, include a cable network, and at least one of the clients 102 may be a set-top box, cable-ready game console, or the like. The internetwork 110 may include other networks, such as satellite networks, the Public Switched Telephone Network, WiFi networks, WiMax networks, cellular networks, and any other public, private, or dedicated networks that might be used to interconnect devices for transfer of data.

An exemplary client 102 may include a processor, a memory (e.g. RAM), a bus which couples the processor and the memory, a mass storage device (e.g. a magnetic hard disk or an optical storage disk) coupled to the processor and the memory through an I/O controller, and a network interface coupled to the processor and the memory, such as a modem, digital subscriber line (“DSL”) card, cable modem, network interface card, wireless network card, or other interface device capable of wired, fiber optic, or wireless data communications. One example of such a client 102 is a personal computer equipped with an operating system such as Microsoft Windows XP, UNIX, or Linux, along with software support for Internet communication protocols. The personal computer may also include a browser program, such as Microsoft Internet Explorer, Netscape Navigator, or FireFox, to provide a user interface for access to the internetwork 110. Although the personal computer is a typical client 102, the client 102 may also be a workstation, mobile computer, Web phone, VOIP device, television set-top box, interactive kiosk, personal digital assistant, wireless electronic mail device, or other device capable of communicating over the Internet. As used herein, the term “client” is intended to refer to any of the above-described clients 102 or other client devices, and the term “browser” is intended to refer to any of the above browser programs or other software or firmware providing a user interface for navigating an internetwork 110 such as the Internet.

An exemplary server 104 includes a processor, a memory (e.g. RAM), a bus which couples the processor and the memory, a mass storage device (e.g. a magnetic or optical disk) coupled to the processor and the memory through an I/O controller, and a network interface coupled to the processor and the memory. Servers may be clustered together to handle more client traffic and may include separate servers for different functions such as a database server, an application server, and a Web presentation server. Such servers may further include one or more mass storage devices such as a disk farm or a redundant array of independent disk (“RAID”) system for additional storage and data integrity. Read-only devices, such as compact disk drives and digital versatile disk drives, may also be connected to the servers. Suitable servers and mass storage devices are manufactured by, for example, Compaq, IBM, and Sun Microsystems. Generally, a server 104 may operate as a source of content and provide any associated back-end processing, while a client 102 is a consumer of content provided by the server 104. However, it should be appreciated that many of the devices described above may be configured to respond to remote requests, thus operating as a server, and the devices described as servers 104 may operate as clients of remote data sources. In contemporary peer-to-peer networks and environments such as RSS environments, the distinction between clients and servers blurs. Accordingly, as used herein, the term “server” as used herein is generally intended to refer to any of the above-described servers 104, or any other device that may be used to provide content such as RSS feeds in a networked environment.

In one aspect, one or more of the servers 104 may provide a search engine. The search engine may provide a variety of functions known in the art. For example, the search engine may locate content on the internetwork 110 using spiders or other location technologies, and index any located content in a database in searchable form. The search engine may also provide an interface for receiving search requests and providing search results. In one familiar approach, the interface may be a web-based interface that receives a textual search string and responds with a list of links to search results ranked by relevance to the search string. In other embodiments, the search engine may provide a programming interface for receiving search requests in a specified format and providing search results.

In one aspect, a client 102 or server 104 as described herein may provide OPML-specific functionality or, more generally, functionality to support a system using outlining grammar or markup language with processing, storage, search, routing, and the like.

For example, the network 100 may include an OPML or RSS router. While the following discussion details routing of OPML content, it will be understood that the system described may also, or instead, be employed for RSS or any other outlined or syndicated content. The network 100 may include a plurality of clients 102 that are OPML users and a number of servers 104 that are OPML sources connected via an internetwork 110. Any number of clients 102 and servers 104 may participate in such a network 100. A device within the internetwork 110 such as a router or, on an enterprise level, a gateway or other network edge or switching device, may cache popular data feeds to reduce redundant traffic through the internetwork 110. In other network enhancements, clients 102 may be enlisted to coordinate sharing of data feeds using techniques such as those employed in a BitTorrent peer-to-peer network. In the systems described herein, these and other techniques generally may be employed to improve performance of an OPML data network.

A router generally may be understood as a computer networking device that forwards data packets across an internetwork through a process known as routing. A router may act as a junction between two networks, transferring data packets between them and validating that information is sent to the correct location. Routing most typically is associated with Internet Protocol (IP); however, specialized routers exist for routing particular types of data, such as ADSL routers for routing signals across digital subscriber lines, or Asynchronous Transfer Mode (“ATM”) switches that maintain so-called virtual circuits in an ATM network. An OPML router may route data across an internetwork, such as the Internet, which may include data in OPML format. In particular, the OPML router may be configured to route data in response to or in correspondence with the structure or the content of an OPML document. That is, various species of OPML router may be provided that correspond to user-developed outline structures in OPML. For example, a financial services OPML outline may contain explicitly labeled content relating to financial services, and this content can be routed by a financial services OPML router that is configured to route financial services data among constituent networks of one or more financial services institutions. Because OPML provides explicit structure and hierarchy, different portions of an OPML document may be routed by different OPML routers, permitting content or semantic-based routing of data. Using the techniques described below, OPML routers may also inspect authenticated metadata, or authenticate metadata, when applying rules for routing OPML content. Thus, for example, OPML content that is explicitly labeled as, e.g., financial services data, may be inspected for a certificate from an authorized financial services entity before applying corresponding routing rules.

An OPML router may use a configuration table, also known as a routing table, to determine the appropriate route for sending a packet, including an OPML data packet. The configuration table may include information on which connections lead to particular groups of addresses, connection priorities, and rules for handling routine and special types of network traffic. In embodiments, the configuration table is dynamically configurable in correspondence to the incoming structure of an OPML data packet; that is, an OPML structure may be provided that includes routing instructions that are automatically executed by the OPML router. In other embodiments, a configuration table is configured to route particular portions of an OPML-structured document to particular addresses. In embodiments an OPML router includes rules that can be triggered by OPML content, such as rules for prioritizing nodes, rules for routing OPML content to particular locations, rules for filtering OMPL content, rules for broadcasting or narrowcasting OPML content, and the like. The rules may be triggered by the structure of an OPML document, the title, metadata, semantic metadata, or one or more content items within the OPML document.

In the process of transferring data between networks, an OPML router may perform translations of various protocols between the two networks, including, for example, translating data from one data format to another, such as taking RSS input data and outputting data in another format. In embodiments the OPML router may also protect networks from one another by preventing the traffic on one from unnecessarily spilling over to the other, or it may perform a security function by using rules that limit the access that computers from outside the network may have to computers inside the network. The security rules may be triggered by the content of the OPML document, the structure of an OPML document, or other features, such as the author, title, or the like. For example, an OPML router may include an authentication facility that requires an OPML document to contain a password, a particular structure, an embedded code, or the like in order to be routed to a particular place. Such a security feature can protect networks from each other and can be used to enable features such as version control.

OPML routers may be deployed in various network contexts and locations. An OPML edge router may connect OPML clients to the Internet. An OPML core router may serve solely to transmit OPML and other data among other routers. Data traveling over the Internet, whether in the form of a Web page, a downloaded file or an e-mail message, travels over a packet-switching network. In this system, the data in a message or file is broken up into packages approximately 1,500 bytes long. Each of these packages has a “wrapper” that includes information on the sender's address, the receiver's address, the package's place in the entire message, and how the receiving computer can be sure that the package arrived intact. Each data package, called a packet, is then sent off to its destination via the best available route. In embodiments, the OPML router determines the best available route taking into account the structure of the OPML document, including the need to maintain associations among packets. A selected route may be taken by all packets in the message or only a single packet in a message. By packaging data in this manner, a network can continuously balance the data load on its equipment. For example, if one component of a network is overloaded or malfunctioning, data packets may be routed for processing on other network equipment that has a lighter data load and/or is properly working. An OPML router may also route OPML content according to semantic structure. For example, an OPML router configured to handle medical records may route X-Rays to an expert in reading X-Rays while routing insurance information to another department of a hospital.

Routers may reconfigure the paths that data packets take because they look at the information surrounding the data packet and can communicate with each other about line conditions within the network, such as delays in receiving and sending data and the overall traffic load on a network. An OPML router may communicate with other OPML routers to determine, for example, whether the entire structure of an OPML document was preserved or whether recipients of a particular component in fact received the routed component. Again, the OPML document itself may include a structure for routing it. A router may also locate preferential sources for OPML content using caching and other techniques. Thus, for example, where an OPML document includes content from an external reference, the external reference may be a better source for that portion of the OPML document based upon an analysis of, e.g., network congestion, geographic proximity, and the like.

An OPML router may use a subnet mask to determine the proper routing for a data packet. The subnet mask may employ a model similar to IP addressing. This tells the OPML router that all messages in which the sender and receiver have an address sharing the first three groups of numbers are on the same network and shouldn't be sent out to another network. For example, if a computer at address 15.57.31.40 sends a request to the computer at 15.57.31.52., the router will match the first three groups in the IP addresses (15.57.31) and keep the packet on the local network. OPML routers may be programmed to understand the most common network protocols. This programming may include information regarding the format of addresses, the format of OPML documents, the number of bytes in the basic package of data sent out over the network, and the method which insures all the packages reach their destination and get reassembled, including into the structure of an OPML document, if desired.

There are two major routing algorithms in common use: global routing algorithms and decentralized routing algorithms. In decentralized routing algorithms, each router has information about the routers to which it is directly connected but does not know about every router in the network. These algorithms are also known as DV (distance vector) algorithms. In global routing algorithms, every router has complete information about all other routers in the network and the traffic status of the network. These algorithms are also known as LS (link state) algorithms. In LS algorithms, every router identifies the routers that are physically connected to them and obtains their IP addresses. When a router starts working, it first sends a “HELLO” packet over the network. Each router that receives this packet replies with a message that contains its IP address. All routers in the network measure the delay time (or any other important parameters of the network, such as average traffic) for its neighboring routers within the network. In order to do this, the routers send echo packets over the network. Every router that receives these packets replies with an echo reply packet. By dividing round trip time by two, routers can compute the delay time. This delay time includes both transmission and processing times (i.e., the time it takes the packets to reach the destination and the time it takes the receiver to process them and reply). Because of this inter-router communication, each OPML router within the network knows the structure and status of the network and can use this information to select the best route between two nodes of a network.

The selection of the best available route between two nodes on a network may be done using an algorithm, such as the Dijkstra shortest path algorithm. In this algorithm, an OPML router, based on information that has been collected from other OPML routers, builds a graph of the network. This graph shows the location of OPML routers in the network and their links to each other. Every link is labeled with a number called the weight or cost. This number is a function of delay time, average traffic, and sometimes simply the number of disparate links between nodes. For example, if there are two links between a node and a destination, the OPML router chooses the link with the lowest weight.

Closely related to the function of OPML routers, OPML switches may provide another network component that improves data transmission speed in a network. OPML switches may allow different nodes (a network connection point, typically a computer) of a network to communicate directly with one another in a smooth and efficient manner. Switches that provide a separate connection for each node in a company's internal network are called LAN switches. Essentially, a LAN switch creates a series of instant networks that contain only the two devices communicating with each other at that particular moment. An OPML switch may be configured to route data based on the OPML structure of that data.

In one embodiment, an OPML router may be a one-armed router used to route packets in a virtual LAN environment. In the case of a one-armed router, the multiple attachments to different networks are all over the same physical link. OPML routers may also function as an Internet gateway (e.g., for small networks in homes and offices), such as where an Internet connection is an always-on broadband connection like cable modem or DSL.

The network 100 may also, or instead, include an OPML server, as described in greater detail below. OPML has the general format shown in the OPML specification hosted at www.opml.org/spec, the entire contents of which is incorporated herein by reference. An OPML document may be encapsulated within an RSS data feed, may contain one or more RSS channel identifiers or items, or may be a separate document. The structure of an OPML document generally includes OPML delimiters, general authorship and creation data, formatting/viewing data (if any), and a series of outline entries according to a knowledge structure devised by the author.

An OPML server may be provided for manipulating OPML content. The OPML server may provide services and content to clients 102 using, for example, a Web interface, an API, an XML processing interface, an RSS feed, an OPML renderer, and the like.

The OPML server may, for example, provide a search engine service to visitors. Output from the OPML server may be an OPML file, an HTML file, or any other file suitable for rendering to a client device or subsequent processing. The file may, for example, have a name that explicitly contains the search query from which it was created in order to facilitate redistribution, modification, recreation, synchronization, updating, and storage of the OPML file. A user may also manipulate the file, such as by adding or removing outline elements representing individual search results, or by reprioritizing or otherwise reorganizing the results, and the user may optionally store the revised search as a new OPML file. Thus in one aspect the OPML server may create new, original OPML content based upon user queries submitted thereto. In a sense, this function is analogous to the function of aggregators in an RSS syndication system, where new content may be dynamically created from a variety of different sources and republished in a structured form.

The OPML server may, more generally, provide a front-end for an OPML database that stores OPML content. The OPML database may store OMPL data in a number of forms, such as by casting the OPML structure into a corresponding relational database where each OPML file is encapsulated as one or more records. The OPML database may also store links to external OPML content or may traverse OPML content through any number of layers and store data, files, and the like externally referenced in OPML documents. Thus, for example, where an OPML file references an external OPML file, that external OPML file may be retrieved by the database and parsed and stored. The external OPML file may, in turn, reference other external OPML files that may be similarly processed to construct, within the database, an entire OPML tree. The OMPL database may also, or instead, store OPML files as simple text or in any number of formats optimized for searching (such as a number of well-known techniques used by large scale search engines Google, AltaVista, and the like), or for OPML processing, or for any other purpose(s). The OPML database may provide coherency for formation of an OPML network among an array of clients 102 and servers 104, where content within the network 100 is structured according to user-created OPML outlines.

The OPML server may provide a number of functions or services related to OPML content. For example, the OPML server may permit a user to publish OPML content, either at a hosted site or locally from a user's computer. The OPML server may provide a ping service for monitoring updates of OPML content. The OPML server may provide a validation service to validate content according to the OPML specification. The OPML server may provide a search service or function which may permit searching against a database of OPML content, or it may provide user-configurable spidering capabilities to search for OPML content across a wide area network. The OPML server may provide an interface for browsing (or more generally, navigating) and/or reading OPML content. The OPML server may provide tools for creating, editing, and/or managing OPML content. The OPML server may authenticate third-party OPML content through communications with OPML sources or a trusted third party, or may act as a certificate authority for other OPML users, or may operate as a trusted third party to authenticate content for others. The OPML server may also provide complementary encryption, decryption, and digital signature functions for use with OPML content and/or metadata.

The OPML server may provide a number of complementary functions or services to support OPML-based transactions, content management, and the like. In one aspect, a renderer or converter may be provided to convert between a structured format such as OPML and a presentation format such as PowerPoint and display the respective forms. While the converter may be used with OPML and PowerPoint, it should be understood that the converter may be usefully employed with a variety of other structured, hierarchical, or outlined formats and a variety of presentation formats or programs. For example, the presentation format may include Portable Document Format, Flash Animation, electronic books, a variety of Open Source alternatives to PowerPoint (e.g., OpenOffice.org's Presenter, KDE's KPresenter, HTML Slidy, and so forth), whether or not they are PowerPoint compatible. The structured format may include OPML, an MS Word outline, simple text, or any other structured content, as well as files associated with leaf nodes thereof, such as audio, visual, moving picture, text, spreadsheet, chart, table, graphic, or any other format, any of which may be rendered in association with the structured format and/or converted between a structured format and a presentation format It will also be understood that the converter may be deployed on a client device for local manipulation, processing, and/or republication of content.

The OPML database may, for example, operate through the OPML server to generate, monitor, and/or control spiders that locate OPML content. A spider may, upon identification of a valid OPML file, retrieve the file and process it into the database. A spider may also process an OPML file to identify external references, systematically traversing an entire OPML tree. A spider may be coordinated using known techniques to identify redundant references within a hierarchy. A spider may also differentiate processing according to, e.g., structure, content, location, file types, metadata, and the like. The user interface described below may also include one or more tools for configuring spiders, including a front end for generating initial queries, displaying results, and tagging results with any suitable metadata.

By way of example, and not of limitation, medical records may be stored as OPML files, either within the database or in a distributed fashion among numerous locations across the OPML network. Thus, for example, assorted X-Ray data may be maintained in one location, MRI data in another location, patient biographical data in another location, and clinical notes in another location. These data may be entirely decoupled from individual patients (thus offering a degree of security/privacy) and optionally may include references to other content, such as directories of other types of data, directories of readers or interpretive metadata for understanding or viewing records, and the like. Separately, OPML files may be created to provide structure to the distributed data. For example, a CT Scan OPML master record may index the locations of all CT Scan records, which may be useful, for example, for studies or research relating to aggregated CT Scan data. This type of horizontal structure may be captured in one or more OPML records which may themselves be hierarchical. Thus, for example, one OPML file may identify participating hospitals by external reference to OPML records for those hospitals. Each hospital may provide a top-level OPML file that identifies OPML records that are available, which may in turn identify all CT Scan records maintained at that hospital. The CT Scan master record may traverse the individual hospital OPML records to provide a flattened list of CT Scan records available in the system. As another example, an OPML file may identify medical data for a particular patient. This OPML file may traverse records of any number of different hospitals or other medical institutions, or it may directly identify particular records where, for example, concerns about confidentiality cause institutions to strip any personally identifying data from records. For certain applications, it may be desirable to have a central registry of data so that records such as patient data are not inadvertently lost due to, for example, data migration within a particular hospital.

Thus in one embodiment there is generally disclosed herein a pull-based data management system in which atomic units of data are passively maintained at any number of network-accessible locations, while structure is imposed on the data through atomic units of relationship that may be arbitrarily defined through OPML or other grammars. The source data may be selectively pulled and organized according to user-defined OPML definitions. The OPML server and OPML database may enable such a system by providing a repository for organization and search of source data in the OPML network. Traversing OPML trees to fully scope an outline composed of a number of nested OPML outlines may be performed by a client 102 or may be performed by the OPML server, either upon request from a client 102 for a particular outline or continually in a manner that insures integrity of external reference links.

In another aspect, there is disclosed herein a link maintenance system for use in an OPML network. In general, a link maintenance system may function to insure integrity of external references contained within OPML files. Broken links, which may result for example from deletion or migration of source content, may be identified and addressed in a number of ways. For example, a search can be performed using the OPML server and OPML database for all OPML files including a reference to the missing target. Additionally, the OPML server and/or OPML database may include a registry of content sources including an e-mail contact manager/administrator of outside sources. Notification of the broken link including a reference to the content may be sent to all owners of content. Optionally, the OPML server may automatically modify content to delete or replace the reference, assuming the OPML server has authorization to access such content. The OPML server may contact the owner of the missing content. The message to the owner may include a request to provide an alternative link which may be forwarded to owners of all content that references the missing content. If the referenced subject matter has been fully indexed by the OPML server and/or OPML database, the content may itself be reconstructed and a replacement link to the location of the reconstructed content provided. Various combinations of reconstruction and notification, such as those above, may be applied to maintain the integrity of links in OPML source files indexed in the database. In various embodiments the links may be continuously verified and updated, or the links may be updated only when an OPML document with a broken link is requested by a client 102 and processed or traversed by the client 102 or the OPML server in response.

The OPML server may provide a client-accessible user interface to view items in a data stream or OMPL outline. The user interface may be presented, for example, through a Web page viewed using a Web browser or through an outliner or outline viewer specifically adapted to display OPML content. In general, an RSS or OPML file may be converted to HTML for display at a Web browser of a client 102. For example, the source file on a server 104 may be converted to HTML using a Server-Side Include (“SSI”) to bring the content into a template by iterating through the XML/RSS internal structure. The resulting HTML may be viewed at a client 102 or posted to a different server 104 along with other items. The output may also, or instead, be provided in OPML form for viewing through an OPML renderer. Thus, feeds and items may be generally mixed, shared, forwarded, and the like in a variety of formats.

Again it is noted that specific references to OPML and RSS above are not intended to be limiting and more generally should be understood as references to any outlining, syndication, or other grammar suitable for use with the systems described herein. Referring still to FIG. 1, a syndication system is now described in greater detail. In general operation, a server 104 may provide a data stream to a client 102. In an exemplary embodiment, the data stream may be a syndicated data stream such as RSS, an XML grammar for sharing data through the Web. An RSS-enabled server may include an RSS file with a title and description of items to be syndicated. As with simple HTML documents, the RSS file may be hand-coded or computer-generated. In general, the RSS file may begin with one or more declarations that specify an RSS channel. Individual items or “posts” within an RSS channel may also include declarations and a range of metadata, typically delimited by XML tags within the body of the corresponding document(s).

The RSS element is the root or top-level element of an RSS file. The root element is the top-level element that contains the rest of an XML document. An RSS element may contain a channel with a title (the name of the channel), description (short description of the channel), link (HTML link to the channel Web site), language (language encoding of the channel, such as en-us for U.S. English), and one or more item elements. A channel may also contain the following optional elements: rating—an independent content rating, such as a PICS rating; copyright—copyright notice information; pubDate—date the channel was published; lastBuildDate—date the RSS was last updated; docs—additional information about the channel; managingEditor—channel's managing editor; webMaster—channel Webmaster; image—channel image; textinput—allows a user to send an HTML form text input string to a URL; skipHours—the hours that an aggregator should not collect the RSS file; skipDays—the weekdays that an aggregator should not collect the RSS file. As a matter of syntax, these attributes may be delimited within the file, as noted above, with corresponding tags.

A channel may contain an image or logo. In RSS, the image element contains the image title and the URL of the image itself. The image element may also include the following optional elements: a link (a URL that the image links to), a width, a height, and a description (additional text displayed with the image). There may also be a text input element for an HTML text field. The text input element may include a title (label for a submit button), description, name, and link (to send input). The link may enable richer functionality, such as allowing a user to submit search terms, send electronic mail, or perform any other text-based function.

Once defined in this manner, a channel may contain a number of items, although some services (e.g., Netscape Netcenter) may limit the number. In general, the “item” elements provide headlines and summaries of the content to be shared. New items may be added, either manually or automatically (such as through a script), by appending them to the RSS file. Each item may include additional metadata, which may be created by an author or publisher of the metadata, or may be computer-supplied during handling of the item using any appropriate metadata enrichment techniques such a semantic analysis of content, authentication of source, and so forth.

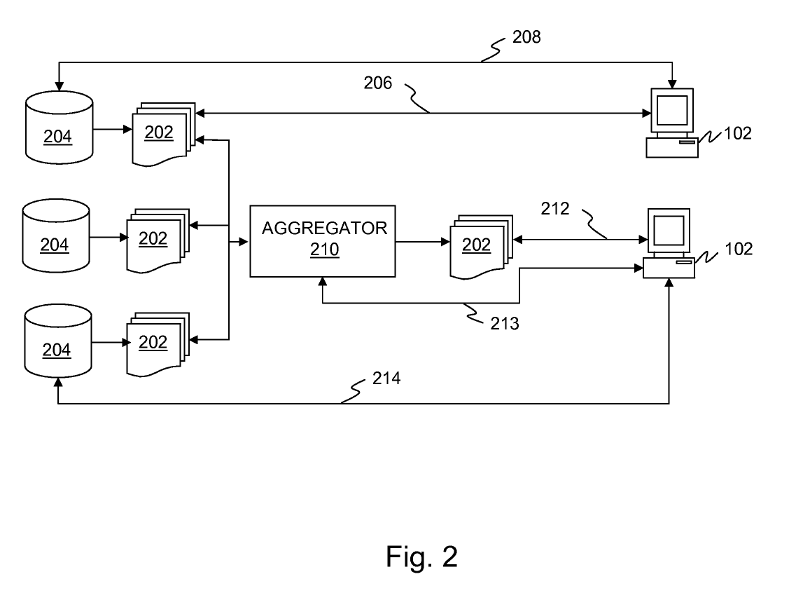

FIG. 2 depicts a system for using and aggregating data feeds or other syndicated content. In general, data feeds 202, such as RSS source files, are generated from a content source 204 and made available for use or review by clients 102 through a network.

The content source 204 may provide any electronic content including newspaper articles; Web magazine articles; academic papers; government documents such as court opinions, administrative rulings, regulation updates, or the like; opinions; editorials; product reviews; movie reviews; financial or market analysis; current events; bulletins; and the like. The content may include text, formatting, layout, graphics, audio files, image files, movie files, word processing files, spreadsheet files, presentation files, electronic documents, HTML files, executable files, scripts, multi-media, relational databases, data from relational databases and/or any other content type or combination of types suitable for syndication through a network. The content source 204 may be any commercial media provider(s) such as newspapers, news services (e.g., Reuters or Bloomberg), or individual journalists such as syndicated columnists. The content source 204 may also be from commercial entities such as corporations, non-profit corporations, charities, religious organizations, social organizations, or the like, as well as from individuals with no affiliation to any of the foregoing. The content source 204 may be edited, as with news items, or automated, as with data feeds 202 such as stock tickers, sports scores, weather conditions, and so on. While written text is commonly used in data feeds 202, it will be appreciated that any digital media may be binary encoded and included in an item of a data feed 202 such as RSS. For example, data feeds 202 may include audio, moving pictures, still pictures, executable files, application-specific files (e.g., word processing documents or spreadsheets), and the like. It should also be understood that, while a content source 204 may generally be understood as a well defined source of items for a data feed, the content source 204 may be more widely distributed or subjectively gathered by a user preparing a data feed 202. For example, an individual user interested in automotive mechanics may regularly read a number of related magazines and regularly attend trade shows. This information may be processed on an ad hoc basis by the individual and placed into a data feed 202 for review and use by others. Thus it will be understood that the data stream systems described herein may have broad commercial use, as well as non-commercial, educational, and mixed uses.

As described generally above, the data feed 202 may include, for each item of content, summary information such as a title, synopsis or abstract (or a teaser, for more marketing oriented materials), and a link to the underlying content. Thus as depicted in FIG. 2, when a client 102 accesses a data feed 202, as depicted by an arrow 206, the client 102 may then display the summary information for each item in a user interface. A client 102 may, in response to user input such as clicking on a title of an item in the user interface, retrieve the underlying item from the content source 204 as indicated by an arrow 208. In the bi-directional communication depicted by the arrow 208, the client 102 may also identify the specific data feed 202 through which the item was identified, which may be useful for tracking distribution channels, customer behavior, affiliate referral fees, and so forth. It should be appreciated that an RSS data feed 202 may be presented to a client 102 as an RSS file (in XML format) that the client 102 locally converts to HTML for viewing through a Web browser, or the data feed 202 may be converted to HTML at a Web site that responds to HTTP requests from a client 102 and responds with an HTML-formatted data feed.

A related concept is the so-called “permalink” that provides a permanent URL reference to a source document that may be provided from, for example, a dynamically generated Web site or a document repository served from a relational database behind a Web server. While there is no official standard for permalink syntax or usage, they are widely used in conjunction with data feeds. Permalinks typically consist of a string of characters which represent the date and time of posting, and some (system dependent) identifier (which includes a base URL, and often identifies the author, subscriber, or department which initially authored the item). If an item is changed, renamed, or moved, its permalink remains unaltered. If an item is deleted altogether, its permalink cannot be reused. Permalinks are exploited in a number of applications including link tracing and link track back in Weblogs and references to specific Weblog entries in RSS or Atom syndication streams. Permalinks are supported in most modern weblogging and content syndication software systems, including Movable Type, LiveJournal, and Blogger. Sub-elements of an RSS post (or an OPML document), such as metadata or individual lines of XML code, may be assigned globally unique identifiers which permit finer granularity for reference and retrieval.

RSS provides a standard format for the delivery of content through data feeds. This makes it relatively straightforward for a content provider to distribute content broadly and for an affiliate to receive and process content from multiple sources. It will be appreciated that other RSS-compliant and/or non-RSS-compliant feeds may be syndicated as that term is used herein and as is described in greater detail below. As noted above, the actual content may not be distributed directly, only the headlines, which means that users will ultimately access the content source 204 if they're interested in a story. It is also possible to distribute the item of content directly through RSS, though this approach may compromise some of the advantages of network efficiency (items are not copied and distributed in their entirety) and referral tracking. Traffic to a Web site that hosts a content source 204 can increase in response to distribution of data feeds 202.

Although not depicted, a single content source 204 may also have multiple data feeds 202. These may be organized topically or according to target clients 102. Thus, the same content may have data feeds 202 for electronic mailing lists, PDAs, cell phones, and set-top boxes. For example, a content provider may decide to offer headlines in a PDA-friendly format, or it may create a weekly email newsletter describing what's new on a Web site.

Data feeds 202 in a standard format provide for significant flexibility in how content is organized and distributed. An aggregator 210, for example, may be provided that periodically updates data from a plurality of data feeds 202. In general, an aggregator 210 may make many data feeds 202 available as a single source. As a significant advantage, this intermediate point in the content distribution chain may also be used to customize feeds, and presentation thereof, as well as to filter items within feeds and provide any other administrative services to assist with syndication, distribution, and review of content.

As will be described in greater detail below, the aggregator 210 may filter, prioritize, or otherwise process the aggregated data feeds. A single processed data feed 202 may then be provided to a client 102 as depicted by an arrow 212. The client 102 may request periodic updates from the data feed 202 created by the aggregator 210 as also indicated by an arrow 212. As indicated by an arrow 213, the client 102 may also configure the aggregator 210 such as by adding data streams 202, removing data streams 202, searching for new data streams 202, explicitly filtering or prioritizing items from the data streams 202, or designating personal preferences or profile data that the aggregator 210 may apply to generate the aggregated data feed 202. When an item of interest is presented in the user interface of the client 102, a user may select a link to the item, causing the client 102 to retrieve the item from the associated content source 204 as indicated by an arrow 214. The aggregator 210 may present the data feed 202 as a static web page that is updated only upon an explicit request from the client 102, or the aggregator 210 may push updates to a client 102 using either HTTP or related Web browser technologies, or by updates through some other channel, such as e-mail updates. It will also be appreciated that, while the aggregator 210 is illustrated as separate from the client 102, the aggregator 210 may be realized as a primarily client-side technology, where software executing on the client 102 assumes responsibility for directly accessing a number of data feeds 202 and aggregating/filtering results from those feeds 202.

It will be appreciated that a user search for feeds will be improved by the availability of well organized databases. While a number of Weblogs provide local search functionality, and a number of aggregator services provide lists of available data feeds, there remains a need for a consumer-level searchable database of feed content. As such, one aspect of the systems and methods described herein is a database of data feeds that is searchable by contents as well as metadata such as title and description. In a server used with the systems described herein, the entire universe of known data feeds may be hashed or otherwise organized into searchable form in real time or near real time. The hash index may include each word or other symbol and any data necessary to locate it in a stream and in a post. Using the techniques described herein, the database may also index sub-components of syndicated posts or outlines and assign corresponding globally unique identifiers. The database may also or instead authenticate content, provide certificates for content, or provide authentication of its own content to requesters.

The advent of commonly available data feeds 202, such as RSS feeds, along with tools such as aggregators 210, enables new modes of communication. In one common use, a user may, through a client 102, post aggregated feeds 202 to a Weblog. The information posted on a Weblog may include an aggregated feed 202, one or more data feeds 202 that are sources for the aggregated feed 202, and any personal, political, technical, or editorial comments that are significant to the author. As such, all participants in an RSS network may become authors or sources of content, as well as consumers.

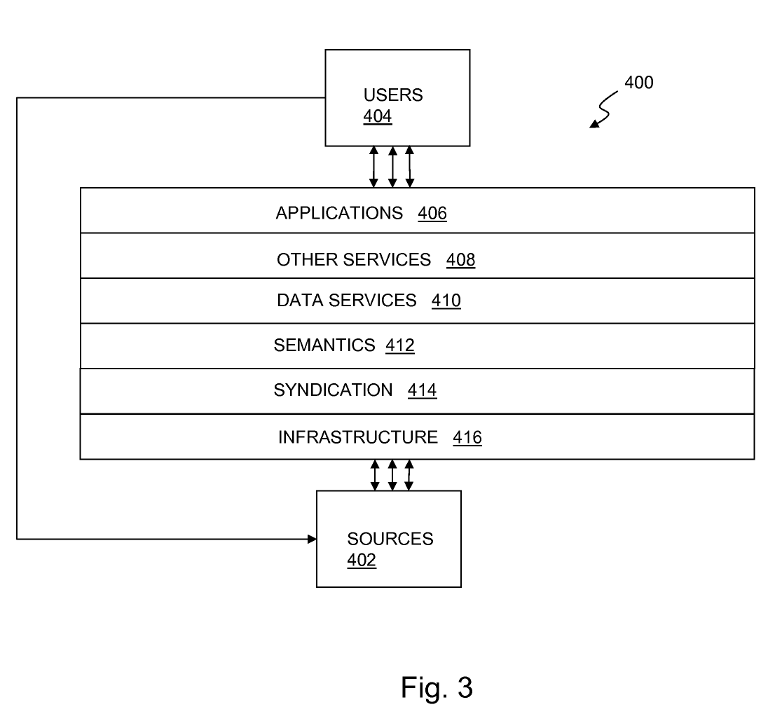

FIG. 3 depicts a conceptual framework for syndicated communications. In a syndication system 400, a plurality of sources 402, which may be for example any of the content sources 204 described above, are published to a plurality of users 404, which may be users of any of the clients 102 described above. Users 404 may include individuals, consumers, business entities, government entities, workgroups, and other categories of users 404. Access to the sources 402 by the users 404 may be through layers of devices, services, and systems (which may be analogous to or actually embodied in a protocol stack) in which various layers are responsible for discrete functions or services, as depicted generally in FIG. 3. However, it will be appreciated that each layer of FIG. 3 may instead be provided as one or more non-layered services. This may include, for example, deployment as services in a Services Oriented Architecture or other Web-based or similar environment where individual services may be located and called from remote locations. An interface to this system may deployed using any suitable technologies including without limitation HTML, Java, AJAX, Microsoft .NET, and so forth. This may also, or instead, include deployment in a fixed architecture where a specific collection of services or functions, such as atomic functions, is deployed either locally or in a distributed manner and accessible through a syntax such as an instruction set. The functions within the conceptual framework may also be deployed within a web application framework such as Ruby on Rails or any other open source, standardized or proprietary application framework. Thus, numerous architectures and variations are possible for deploying the functions and operations described herein, and all such arrangements are intended to fall within the scope of this disclosure.

At the same time, it should be understood that the number, arrangement, and functions of the layers may be varied in a number of ways within a syndication system 400; in particular, depending on the characteristics of the sources, the needs of the users 404 and the features desired for particular applications, a number of improved configurations for syndication systems 404 may be established, representing favorable combinations and sub-combinations of layers depicted in FIG. 3. The layers may provide services such as, for example, services related to applications 406, other services 408 (including relating to processing), services related to data 410, services related to semantics of content 412, syndication services 414, and services related to infrastructure 416. More generally, all of the services and functions described below, either individual or in combinations, as well as other services not specifically mentioned, may be incorporated into an enhanced syndication system as described herein. It should be understood that any of the services depicted in the layers of FIG. 3 may be embodied in hardware, software, firmware, or a combination thereof; for example, a service may be embodied in software as a web service, according to a services oriented architecture. Alternatively, without limitation, a service may be a client-side or server-side application or take any of the forms described herein and in the documents incorporated by reference herein. In one embodiment, one or more layers may be embodied in a dedicated semiconductor device, such as an ASIC, that is configured to enable syndication.

Services related to applications 406 may be embodied, for example, in a client-side application (including commercially available applications such as a word processor, spreadsheet, presentation software, database system, task management system, supply chain management system, inventory management system, human resources management system, user interface system, operating system, graphics system, computer game, electronic mail system, calendar system, media player, and the like), a remote application or service, an application layer of an enhanced syndication services protocol stack, a web service, a service oriented architecture service, a Java applet, or a combination of these. Applications 406 may include, for example, a user interface, social networking, vertical market applications, media viewers, transaction processing, alerts, event-action pairs, analysis, and so forth. Applications 406 may also accommodate vertical market uses of other aspects of the system 400 by integrating various aspects of, for example, security, interfaces, databases, syndication, and the like. Examples of vertical markets include financial services, health care, electronic commerce, communications, advertising, sales, marketing, supply chain management, retail, accounting, professional services, and so forth. In one aspect, the applications 406 may include social networking tools to support functions such as sharing and pooling of syndicated content, content filters, content sources, content commentary, and the like, as well as formation of groups, affiliations, and the like. Social networking tools may support dynamic creation of communities and moderation of dialogues within communities, while providing individual participants with any desired level of anonymity. Social networking tools may also, or instead, evaluate popularity of feeds or items in a syndication network or permit user annotation, evaluation, or categorization. A user interface from the application may also complement other services layers. For example, an application may provide a user interface that interprets semantic content to determine one or more display characteristics for associated items of syndicated content.

Other services 408 may include any other services not specifically identified herein that may be usefully employed within an enhanced syndication system. For example, content from the sources 402 may be formatted for display through a formatting service that interprets various types of data and determines an arrangement and format suitable for display. This may also include services that are specifically identified, which may be modified, enhanced, or adapted to different uses through the other services 408. Other services 408 may support one or more value added services. For example, a security service may provide for secure communications among users or from users to sources. An identity service may provide verification of user or source identities, such as by reference to a trusted third party. An authentication service may receive user credentials and control access to various sources 402 or other services 408 within the system. A financial transaction service may execute financial transactions among users 404 or between users 404 and sources 402. Any service amenable to computer implementation may be deployed as one or more other services 408, either alone or in combination with services from other elements of the system 400. More generally, security services may include public key infrastructure or other key-based security functions such as key creation, key distribution, key management, authentication, digital signatures, certificate management, and so forth.

Data services 410 may be embodied, for example, in a client-side application, a remote application or service, an application layer of an enhanced syndication services protocol stack, as application services deployed, for example, in the services oriented architecture described below, or a combination of these. Data services 410 may include, for example, search, query, view, extract, or any other database functions. Data services 410 may also, or instead, include data quality functions such as data cleansing, deduplication, and the like. Data services 410 may also, or instead, include transformation functions for transforming data between data repositories or among presentation formats. Thus, for example, data may be transformed from entries in a relational database, or items within an OPML outline, into a presentation format such as MS Word, MS Excel, or MS PowerPoint. Similarly, data may be transformed from a source such as an OPML outline into a structured database. Data services 410 may also, or instead, include syndication-specific functions such as searching of data feeds, or items within data feeds, or filtering items for relevance from within selected feeds, or clustering groups of searches and/or filters for republication as an aggregated and/or filtered content source 402. In one aspect, a data service 410 as described herein provides a repository of historical data feeds, which may be combined with other services for user-configurable publication of aggregated, filtered, and/or annotated feeds. More generally, data services 410 may include any functions associated with data including storing, manipulating, retrieving, transforming, verifying, authenticating, formatting, reformatting, tagging, linking, hyperlinking, reporting, viewing, and so forth. A search engine deployed within the data services 410 may permit searching of data feeds or, with a content database as described herein, searching or filtering of content within data feeds from sources 402. Data services 410 may be adapted for use with databases such as commercially available databases from Oracle, Microsoft, IBM, and/or open source databases such as MySQL AB or PostgreSQL.

In one aspect, data services 410 may include services for searching and displaying collections of OPML or other XML-based documents. This may include a collection of user interface tools for finding, building, viewing, exploring, and traversing a knowledge structure inherent or embedded in a collection of interrelated or cross-linked documents. Such a system has particular utility, for example, in creating a structured knowledge directory of OPML structures derived from an exploration of relationships among individual outlined OPML documents and the nodes thereof (such as end nodes that do not link to further content). In one embodiment, the navigation and building of knowledge structures may advantageously be initiated from any point within a knowledge structure, such as an arbitrarily selected OPML document within a tree. A user interface including the tools described generally above may allow a user to restrict a search to specific content types, such as RSS, podcasts (which may be recognized, e.g., by presence of RSS with an MP3 or WAV attachment) or other OPML links within the corpus of OPML files searched. The interface may be supported by a searchable database of OPML content, which may in turn be fed by one or more OPML spiders that seek to continually update content either generally or within a specific domain (i.e., an enterprise, a top-level domain name, a computer, or any other domain that can be defined for operation of a spider. The OPML generated by an OPML search engine may also be searchable, permitting, e.g., recovery of lost links to OPML content.

It will be appreciated that by storing an entire knowledge structure (or entire portions thereof), the tree structure may be navigated in either direction. That is, a tree may be navigated downward in a hierarchy (which is possible with conventional outlines) as well as upward in a hierarchy (which is not supported directly by OPML). Upward navigation becomes possible with reference to a stored version of the knowledge structure, and the navigation system may include techniques for resolving upward references (e.g. where two different OPML documents refer to the same object) using explicit user selections, pre-programmed preferences, or other selection criteria, as well as combinations thereof.

Data services 410 may include access to a database management system (DBMS). In one aspect, the DBMS may provide management of syndicated content. In another aspect, the DBMS may support a virtual database of distributed data. The DBMS may allow a user, such as a human or an automatic computer program, to perform operations on a data feed, references to the data feed, metadata associated with the data feed, and the like. Thus in one aspect, a DBMS is provided for syndicated content. Operations on the data managed by the DBMS may be expressed in accordance with a query language, such as SQL, XQuery, or any other database query language. In some embodiments, the query language may be employed to describe operations on a data feed, on an aggregate of data feeds, or on a distributed set of data feeds. It should be appreciated that the data feeds may be structured according to RSS, OPML, or any other syndicated data format. In another aspect, content such as OPML content may describe a relationship among distributed data, and the data services 410 may provide a virtual DBMS interface to the distributed data. Thus, there is disclosed herein an OPML-based database wherein data relationships are encoded in OPML and data are stored as content distributed among resources referenced by the OPML.

The data services 410 may include database transactions. Each database transaction may include an atomic set of reads and/or writes to the database. The transaction mechanism for the database transactions may support concurrent and/or conditional access to the data in the database. Conditional access may support privacy, security, data integrity, and the like within the database. The transaction mechanism may allow a plurality of users to concurrently read, write, create, delete, perform a query, or perform any other operation supported by the DMBS against an RSS feed or OPML file, either of which may be supported by the data in the database or support a database infrastructure. In one aspect, the transaction mechanism may avoid or resolve conflicting operations and maintain the consistency of the database. The transaction mechanism may be adapted to support availability, scalability, mobility, serializability, and/or convergence of a DBMS. The transaction mechanism may also, or instead, support version control or revision control. The DBMS may additionally or alternatively provide methods and systems for providing access control, record locking, conflict resolution, avoidance of list updates, avoidance of system delusion, avoidance of scaleup pitfall, and the like.

The data services 410 may provide an interface to a DBMS that functions as a content source by publishing or transmitting a data feed to a client. The DBMS may additionally or alternatively perform as a client by accessing or receiving a data feed from a content source. The DBMS may perform as an aggregator of feeds. The DBMS may provide a syndication service. The DBMS may perform as an element in a service-oriented architecture. The DBMS may accept and/or provide data that are formatted according to XML, OPML, HTML, RSS, or any other markup language.

Semantics 412, or semantic processing, may include any functions or services associated with the meaning of content from the sources 402 and may be embodied, for example, in a client-side application, a remote application or service, an application layer of an enhanced syndication services protocol stack, as application services deployed, for example, in the services oriented architecture described below, or a combination of these. Semantics 412 may include, for example, interrelating content into a knowledge structure using, for example, OPML, adding metadata or enriching current metadata, interpreting or translating content, and so forth. Semantics 412 may also include parsing content, either linguistically for substantive or grammatical analysis, or programmatically for generation of executable events. Semantics 412 may include labeling data feeds and items within feeds, either automatically or manually. This may also include interpretation of labels or other metadata, and automated metadata enrichment. Semantics 412 may also provide a semantic hierarchy for categorizing content according to user-specified constraints or against a fixed dictionary or knowledge structure. Generally, any function relating to the categorization, interpretation, or labeling of content may be performed within a semantic layer, which may be used, for example, by users 404 to interpret content or by sources 402 to self-identify content. Categorization may be based on one or more factors, such as popularity, explicit user categorization, interpretation or analysis of textual, graphical, or other content, relationship to other items (such as through an outline or other hierarchical description), content type (e.g., file type), content metadata (e.g., author, source, distribution channel, time of publication, etc.) and so forth. Currently available tools for semantic processing include OPML, dictionaries, thesauruses, and metadata tagging. Current tools also include an array of linguistic analysis tools which may be deployed as a semantic service or used by a semantic service. These and other tools may be employed to evaluate semantic content of an item, including the body and metadata thereof, and to add or modify semantic information accordingly.

It will be understood that, while OPML is one specific outlining grammar, any similar grammar, whether XML-based, ASCII-based, or the like, may be employed, provided it offers a manner for explicitly identifying hierarchies and/or relationships among items within a document and/or among documents. Where the grammar is XML-based, it is referred to herein as an outlining markup language.

Semantics 412 may be deployed, for example, as a semantic service associated with a syndication platform or service. The semantic service may be, for example, a web service, a service in a services oriented architecture, a layer of a protocol stack, a client-side or server-side application, or any of the other technologies described herein, as well as various combinations of these. The semantic service may offer a variety of forms of automated, semi-automated, or manual semantic analysis of items of syndicated content, including feeds or channels that provide such items. The semantic service may operate in one or more ways with syndicated content. In one aspect, the semantic service may operate on metadata within the syndicated content, as generally noted above. The semantic service may also, or instead, store metadata independent from the syndicated content, such as in a database, which may be publicly accessible or privately used by a value-added semantic service provider or the like. The semantic service may also or instead specify relationships among items of syndicated content using an outlining service such as OPML. In general, an outlining service, outlining markup language, outlining syntax, or the like, provides a structured grammar for specifying relationships such as hierarchical relationships among items of content. The relationship may, for example, be a tree or other hierarchical structure that may be self-defined by a number of discrete relationships among individual items within the tree. Any number of such outlines may be provided in an outline-based semantic service.

By way of an example of use of a semantic service, a plurality of items of syndicated content, such as news items relating to a corporate entity, may be aggregated for presentation as a data feed. Other content, such as stored data items, may be associated with the data feed using an outline markup language so that an outline provided by the semantic service includes current events relating to a corporate entity, along with timely data from a suitable data source such as stock quotes, bond prices, or any other financial instrument data (e.g., privately held securities, stock options, futures contracts), and also publicly available data such as SEC filings including quarterly reports, annual reports, or other event reports. All of these data sources may be collected for a company using an outline that structures the aggregated data and provides pointers to a current source of data where the data might change (such as stock quotes or SEC filings). Thus an outline may provide a fixed, structured, and current view of the corporate entity where data from different sources changes with widely varying frequencies. Of course other content, such as message boards, discussion groups, and the like may be incorporated into the outline, along with relatively stable content such as a web site URL for the entity.

Syndication 414 may include any functions or services associated with a publish-subscribe environment and may be embodied, for example, in a client-side application, a remote application or service, an application layer of an enhanced syndication services protocol stack, as application services deployed, for example, in the services oriented architecture described below, or a combination of these. Syndication 412 may include syndication specific functions such as publication, subscription, aggregation, republication, and, more generally, management of syndication information (e.g., source, date, author, and the like). One commonly employed syndication system is RSS, although it will be appreciated from the remaining disclosure that a wide array of enhanced syndication services may provided in cooperation with, or separate from, an RSS infrastructure.

Infrastructure 416 may include any low level functions associated with enhanced syndication services and may be embodied, for example, in a client-side application, a remote application or service, an application layer of an enhanced syndication services protocol stack, as application services deployed, for example, in the services oriented architecture described below, or a combination of these. Infrastructure 416 may support, for example, security, authentication, traffic management, logging, pinging, communications, reporting, time and date services, and the like.

In one embodiment, the infrastructure 416 may include a communications interface adapted for wireless delivery of RSS content. RSS content is typically developed for viewing by a conventional, full-sized computer screen; however, users increasingly view web content, including RSS feeds, using wireless devices, such as cellular phones, Personal Digital Assistants (“PDAs”), wireless electronic mail devices such as Blackberrys, and the like. In many cases content that is suitable for a normal computer screen is not appropriate for a small screen; for example, the amount of text that can be read on the screen is reduced. Accordingly, embodiments of the invention include formatting RSS feeds for wireless devices. In particular, embodiments of the invention include methods and systems for providing content to a user, including taking a feed of RSS content, determining a user interface format for a wireless device, and reformatting the RSS content for the user interface for the wireless device. In embodiments the content may be dynamically reformatted based on the type of wireless device.

The infrastructure 416 may more generally provide traffic management services including but not limited to real time monitoring of message latency, traffic and congestion, and packet quality across a network of end-to-end RSS exchanges and relationships. This may include real time monitoring of special traffic problems such as denial of service attacks or overload of network capabilities. Another service may be Quality-of-Service management that provides a publisher with the ability to manage time of sending of signaling messages for pingers, time of availability of the signaled-about messages, and unique identifiers which apply to the signaling message and the signaled-about message or messages. This may also include quality of service attributes for the signaled-about message or messages and criteria for selecting end user computers that are to be treated to particular levels of end-to-end quality of service. This may be, for example, a commercial service in which users pay for higher levels of QoS.

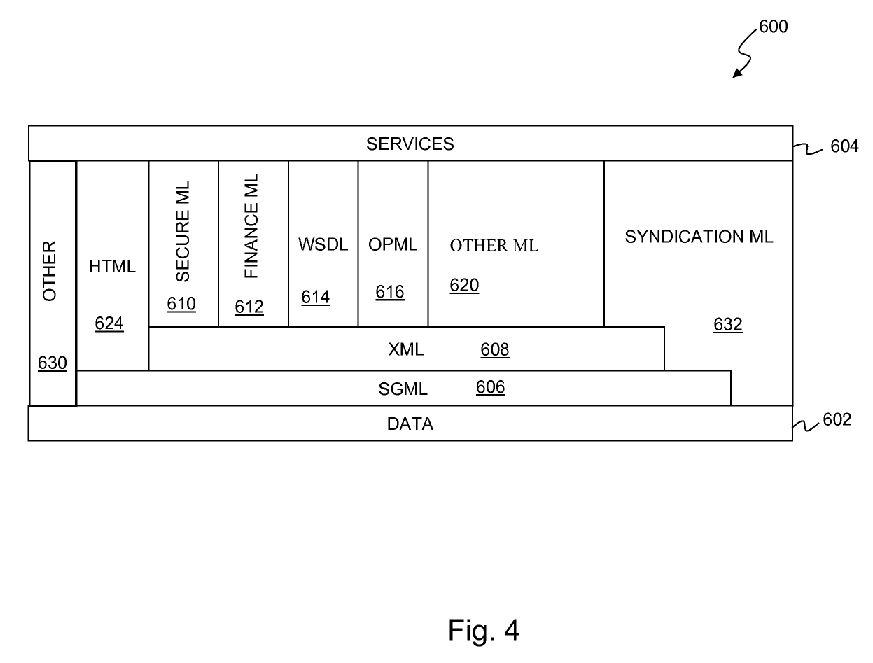

It will be generally appreciated that the arrangement of layers and interfaces may vary; however, in one embodiment syndication 414 may communicate directly with sources 402 while the applications 406 may communicate directly with users 404. Thus, in one aspect, the systems described herein enable enhanced syndication systems by providing a consistent framework for consumption and republication of content by users 404. In general, existing technologies such as RSS provide adequate syndication services, but additional elements of a syndication system 400, such as social networking and semantic content management, have been provided only incrementally and only on an ad hoc basis from specific service providers. There currently exists no open technology infrastructure for enhancing syndication systems such as RSS with value added services. The functions and services described above may be realized through, for example, the services oriented architecture and/or with any of the markup languages described below with reference to FIG. 4.

In one example, the following functions may be arranged in an end-to-end enhanced syndication system: convert, structure, authenticate, store, spider, pool, search, filter, cluster, route, and run. Conversion may transform data (bi-directionally) between application-specific or database-specific formats and the syndication or outlining format. Structure may be derived from the content, such as a knowledge structure inherent in interrelated OPML outlines, or metadata contained in RSS tags. A number of authentication functions may be applied to documents, or to fragments or metadata thereof, such as authenticating with reference to a trusted third party, or acting as a certificate authority for content. Storage may occur locally on a user device or at a remote repository. Spiders may be employed to search repositories and local data on user devices, to the extent that it is made publicly available or actively published. Pools of data may be formed at central repositories or archives. Searches may be conducted across one or more pools of data. Filters may be employed to select specific data feeds, items within a data feed, or elements of an OPML tree structure. Specific items or OPML tree branches may be clustered based upon explicit search criteria, inferences from metadata or content, or community rankings or commentary. Routing may permit combinations among content from various content sources using, e.g., web services or superservices. Such combinations may be run to generate corresponding displays of results. Other similar or different combinations of elements from the broad categories above may be devised according to various value chains or other conceptual models of syndication services.

More generally, well-defined interfaces between a collection of discrete modules for an established value chain may permit independent development, improvement, adaptation, and/or customization of modules by end users or commercial entities. This may include configurations of features within a module (which might be usefully shared with others, for example), as well as functional changes to underlying software.

For example, an author may wish to use any one or more of a number of environments to create content for syndication. By providing a module with a standardized interface to RSS posting, converters may be created for that module to convert between application formats and an RSS-ready format. This may free contributors to create content in any desired format and, with suitable converters, readily transform the content into RSS-ready material. Thus disparate applications such as Microsoft Word, Excel, and Outlook may be used to generate content, with the author leveraging off features of those applications (such as spell checking, grammar checking, calculation capabilities, scheduling capabilities, and so on). The content may then be converted into RSS material and published to an RSS feed. As a significant advantage, users may work in an environment in which they are comfortable and simply obtain needed converters to supply content to the RSS network. As a result, contributors may be able to more efficiently produce source material of higher quality. Tagging tools may also be incorporated into this module (or some author module) to provide any degree of automation and standardization desired by an author for categorization of content.

As another example, appropriate characterization of RSS material remains a constantly growing problem. However, if tagging occurs at a known and predictable point in the RSS chain, e.g., within a specific module, then any number of useful applications may be constructed within, or in communication with, that module to assist with tagging. For example, all untagged RSS posts may be extracted from feeds and pooled at a commonly accessible location where one or more people may resolve tagging issues. Or the module may automatically resolve tagging recommendations contributed by readers of the item. Different rules may be constructed for different streams of data, according to editorial demands or community preferences. Tag-level authentication operations may also be provided to authenticated source, metadata and the like. This may include authentication of data in an original post, or subsequently-added metadata, which may be machine created, obtained from social network systems, inserted as human-created editorial commentary, and so forth. In short, maintaining a separate tagging module, or fixing the tagging function at a particular module within the chain, permits a wide array of tagging functions which may be coordinated with other aspects of the RSS chain.

In another aspect, a well-defined organization of modules permits improved synchronization or coordination of different elements of the modules in the RSS chain. Thus for example centralized aggregators may be provided to improve usability or to improve the tagging of content with metadata, where a combination of lack of standards and constantly evolving topics has frustrated attempts to normalize tagging vocabulary. By explicitly separating tagging from content, visibility of tagging behavior may be improved and yield better tag selection by content authors. Similarly, search techniques (mapping and exploration) may be fully separated from indexing (pre-processing) to permit independent improvements in each.

A well-established “backplane” or other communications system for cooperating RSS modules (or other data feeds) may enable a number of business processes or enterprise applications, particularly if coupled with identity/security/role management, which may be incorporated into the backplane, or various modules connected thereto, to control access to data feeds.

For example, a document management system may be provided using an enhanced RSS system. Large companies, particularly document intensive companies such as professional services firms, including accounting firms, law firms, consulting firms, and financial services firms, employ sophisticated document management systems that provide unique identifiers and metadata for each new document created by employees. Each new document may also, for example, be added to an RSS feed. This may occur at any identifiable point during the document's life, such as when first stored, when mailed, when printed, or at any other time. By viewing the RSS feed with, for example, topical filters, an individual may filter the stream of new documents for items of interest. Thus, for example, a partner at a law firm may remain continuously updated on all external correspondence relating to SEC Regulation FD, compliance with Sarbanes Oxley, or any other matter of interest. Alternatively, a partner may wish to see all documents relating to a certain client. Similarly, a manager at a brokerage house may wish to monitor all trades of more than a certain number of shares for a certain stock. Or an accountant may wish to see all internal memoranda relating to revisions to depreciation allowances in the federal tax code. An enhanced RSS system may provide any number of different perspectives on newly created content within an organization.

Other enterprise-wide applications may be created. For example, a hospital may place all prescriptions written by physicians at the hospital into an RSS feed. This data may be viewed and analyzed to obtain a chronological view of treatment.

In one aspect, functions within the conceptual framework may include a group of atomic functions which may be accessed with a corresponding syntax. Arrangements of such calls into higher-level, more complex operations, may also be expressed in a file such as an OPML file, an XML file, or any other suitable grammar. Effectively, these groups of instructions may form programmatic expressions which may be stored for publication, re-use, and combination with other programmatic expressions. Data for these programmatic expressions may be separately stored in another physical location, in a separate partition at a location of the instructions, or together with the instructions. In one aspect, OPML may provide a grammar for expression of functional relationships, and RSS may provide a grammar for data. Thus the same complex operation may be re-executed against different data sets or against data in a syndicated feed that periodically updates. Thus, in one aspect, an architecture is provided for microprocessor-styled programming across distributed data and instructions.

FIG. 4 shows an XML environment for syndication systems. As represented in FIG. 4, an XML environment 600 includes data 602, which may be any of the content sources or other data sources described above that interacts with services 604, which may execute on a client 102, a server 104, or any other entity within a network.

Services 604, which may be, for example, any of the services described above with reference to FIG. 3, may employ a variety of standards, protocols, and programming languages to interact meaningfully with the data 602. This includes, for example, the use of programming tools that permit program logic to be deployed in, e.g., Java, Windows, Perl, PHP, C/C++, and so on. This also includes parsing, processing, and database access using, e.g., data binding (mapping XML components into native formats of various programming languages), Document Object Model (“DOM”, a programming interface for manipulation of XML/HTML as program objects), Simple API for XML (“SAX”, another API for XML documents), XSL (a stylesheet expression language), XSL Transformations (“XSLT”, a language for transforming XML documents into other XML documents), XML Path Language (“XPATH”, a language for referring to parts of XML documents), XSL Formatting Objects (“XSL-FO”, an XML vocabulary for formatting semantics), and a variety of tools for queries and other access to commercial databases. Further, presentation may be provided using, e.g., XHTML, CSS/XSL-FO, SMIL, WSUI, and a host of other presentation tools. Services 604 may also employ various other XML-oriented tools for messaging, metadata, and web services, including SOAP, XML-RPC, RDF, UDDI, WSDL, and the like. Other specifications, such as the Voice eXtensible Markup Language (VoiceXML), Security Services Markup Language (S2ML), and OASIS Security Assertion Markup Language (SAML), provide special purpose grammars for specific functions. In general, these tools in various combinations permit a relatively arbitrary deployment of functions as services on top of content, structured using XML grammars.

The services 604 may interact with data 602 through one or more established grammars, such as a secure markup language 610, a finance markup language 612, WSDL 614, the Outline Programming Markup Language (“OPML”) 616, or other markup languages 620 based upon XML 608, which is a species of the Standard Generalized Markup Language (“SGML”) 606. The interaction may be also, or instead, through non-XML grammars such as HTML 624 (which is a species of SGML) or other formats 630. More generally, a wide array of XML schemas has been devised for industry-specific and application-specific environments. For example, XML.org lists the following vertical industries with registered XML schemas, including the number of registered schemas in parentheses, all of which may be usefully combined with the systems described herein, and are hereby incorporated by reference in their entirety: Accounting (14), Advertising (6), Aerospace (20), Agriculture (3), Arts/Entertainment (24), Astronomy (14), Automotive (14), Banking (10), Biology (9), Business Reporting (2), Business Services (3), Catalogs (9), Chemistry (4), Computer (9), Construction (8), Consulting (20), Customer Relation (8), Customs (2), Databases (11), E-Commerce (60), EDI (18), ERP (4), Economics (2), Education (51), Energy/Utilities (35), Environmental (1), Financial Service (53), Food Services (3), Geography (5), Healthcare (25), Human Resources (23), Industrial Control (5), Insurance (6), Internet/Web (35), Legal (10), Literature (14), Manufacturing (8), Marketing/PR (1), Math/Data, Mining (10), Multimedia (26), News (12), Other Industry (12), Professional Service (6), Public Service (5), Publishing/Print (28), Real Estate (16), Religion, Retail (6), Robotics/AI (5), Science (64), Security (4), Social Sciences (4), Software (129), Supply Chain (23), Telecommunications (26), Translation (7), Transportation (10), Travel (4), Waste Management, Weather (6), Wholesale, and XML Technologies (238).

Syndication services, described in more detail below, may operate in an XML environment through a syndication markup language 632, which may support syndication-specific functions through a corresponding data structure. One example of a currently used syndication markup language 632 is RSS. However, it will be appreciated that a syndication markup language (“SML”) as described herein may include any structure suitable for syndication, including RSS, RSS with extensions (RSS+), RSS without certain elements (RSS−), RSS with variations to elements (RSS′), or various combinations of these (e.g., RSS′−, RSS′+). Furthermore, an SML 632 may incorporate features from other markup languages, such as a financial markup language 612 and/or a secure markup language 610, or may be used in cooperation with these other markup languages 620. More generally, various combinations of XML schemas may be employed to provide syndication with enhanced services as described herein in an XML environment. It will be noted from the position of SML 632 in the XML environment that SML 632 may be XML-based, SGML-based, or employ some other grammar for services 604 related to syndication. All such variations to the syndication markup language 632 as may be usefully employed with the systems described herein are intended to fall within the scope of this disclosure and may be used in a syndication system as that term is used herein.

According to the foregoing, there is disclosed herein an enhanced syndication system. In one aspect, the enhanced syndication system permits semantic manipulation of syndicated content. In another aspect, the enhanced syndication system offers a social networking interface which permits various user interactions without a need to directly access underlying syndication technologies and the details thereof. In another aspect, a wide variety of additional services may be deployed in combination with syndicated content to enable new uses of syndicated content. In another aspect, persistence may be provided to transient syndicated content by the provision of a database or archive of data feeds, and particularly the content of data feeds, which may be searched, filtered, or otherwise investigated and manipulated in a syndication network. Such a use of a syndication system with a persistent archive of data feeds and items therein is now described in greater detail.

The syndication markup language 632, or the syndication markup language 632 in combination with other supporting markup languages and other grammars including but not limited to RSS, OPML, XML and/or any other definition, grammar, syntax, or format, either fixed or extensible, all as described in more detail below, may support syndication-related communications and functions. Syndication communications may generally occur through an internetwork between a subscriber and a publisher, with various searching, filtering, sorting, archiving, modifying, and/or outlining of information as described herein.

Two widely known message definitions for syndicated communications are RSS 2.0 (RSS) and the Atom Syndication Format Draft Version 9 (Atom, as submitted to the IETF on Jun. 7, 2005 in the form of an Internet-Draft). A syndication message definition, as used herein, will be understood to include these definitions as well as variations, modifications, extensions, simplifications, and the like as described generally herein. Thus, a syndication message definition will be understood to include the various XML specifications and other grammars described herein and may support corresponding functions and capabilities that may or may not include the conventional publish-subscribe operations of syndication. A syndication definition may be described in terms of XML or any other suitable standardized or proprietary format. XML, for example, is a widely accepted standard of the Internet community that may conveniently offer a human-readable and machine-readable format. Alternatively, the syndication definition may be described according to another syntax and/or formal grammar.

For purposes of establishing a general vocabulary, and not by way of limitation, components of syndicated communications are now described in greater detail.

A message instance, or message, may conform to a message definition, which may be an abstract, typed definition. The abstract, typed definition may be expressed, for example, in terms of an XML schema, which may without limitation comprise XML's built-in Document Type Definition (DTD), XML Schema, RELAX NG, and so forth. In some cases, information may lend itself to representation as a set of message instances, which may be atomic, and may be ordered and/or may naturally occur as a series. It should be appreciated that the information may change over time and that any change in the information may naturally be associated with a change in a particular message instance and/or a change in the set of message instances. A data feed or data stream may include a set of messages. In an RSS environment, a message instance may be referred to as an entry. In an OPML environment, the message instance may be referred to as a list. More generally, a message may include any elements of the syndication message definition noted above. Thus, it will be appreciated that the terms “list,” “outline,” “message,” “item,” and the like may be used interchangeably in the description of enhanced syndication systems herein. All such meanings are intended to fall within the scope of this disclosure unless a more specific meaning is expressly indicated or clear from the context. A channel definition may provide metadata associated with a data feed, and a subscription request may include a URI or other metadata identifying a data feed and/or data feed location. The location may without limitation comprise a network address, indication of a network protocol, path, virtual path, filename, and any other suitable identifying information.

A syndication message definition may include any or all of the elements of the following standards and drafts, all of which are hereby incorporated in their entirety by reference: RSS 2.0; Atom Syndication Format as presented in the IETF Internet-Draft Version 9 of the Atom Syndication Format; OPML 1.0; XML Signature Syntax (as published in the W3C Recommendation of 12 Feb. 2002); the XML Encryption Syntax (as published in the W3C Recommendation of 10 Dec. 2002); and the Common Markup for Micropayment per-fee-links (as published in the W3C Working Draft of 25 Aug. 1999). In summary, these elements, which are described in detail in the above documents, may include the following: channel, title, link, description, language, copyright, managing editor (managingEditor), Web master (webmaster), publication date (pubDate), last build date (lastBuildDate), category, generator, documentation URL (docs), cloud, time to live (ttl), image, rating, text input (textInput), skip hours (skipHours), skip days (skipDays), item, author, comments, enclosure, globally unique identifier (guid), source, name, URI, email, feed, entry, content, contributor, generator, icon, id, logo, published, rights, source, subtitle, updated, opml, head, date created (dateCreated), date modified (dateModified), owner name (ownerName), owner e-mail (ownerEmail), expansion state (expansionState), vertical scroll state (vertScrollState), window top (windowTop), window left (windowLeft), window bottom (windowBottom), window right (windowRight), head, body, outline, signature (Signature), signature value (SignatureValue), signed information (SignedInfo), canonicalization method (CanonicalizationMethod), signature method (SignatureMethod), reference (Reference), transforms (Transforms), digest method (DigestMethod), digest value (DigestValue), key information (KeyInfo), key value (KeyValue), DSA key value (DSAKeyvalue), RSA key value (RSAKeyValue), retrieval method (RetrievalMethod), X509 data (X509Data), PGP Data (PGPData), SPKI Data (SPKIData), management data (MgmtData), object (Object), manifest (Manifest), signature properties (SignatureProperties), encrypted type (EncryptedType), encryption method (EncryptionMethod), cipher data (CipherData), cipher reference (CipherReference), encrypted data (EncryptedData), encrypted key (EncryptedKey), reference list (ReferenceList), encryption properties (EncryptionProperties), price, text link (textlink), image link (imagelink), request URL (request URL), payment system (paymentsystem), buyer identification (buyerid), base URL (baseurl), long description (longdesc), merchant name (merchantname), duration, expiration, target, base language (hreflang), type, access key (accesskey), character set (charset), external metadata (ExtData), and external data parameter (ExtDataParm).

A syndication definition may also include elements pertaining to medical devices, crawlers, digital rights management, change logs, route traces, permanent links (also known as permalinks), time, video, devices, social networking, vertical markets, downstream processing, and other operations associated with Internet-based syndication. The additional elements may, without limitation, comprise the following: clinical note (ClinicalNote), biochemistry result (BiochemistryResult), DICOM compliant MRI image (DCMRI), keywords (Keywords), license (License), change log (ChangeLog), route trace (RouteTrace), permalink (Permalink), time (Time), shopping cart (ShoppingCart), video (Video), device (Device), friend (Friend), market (Market), downstream processing directive (DPDirective), set of associated files (FileSet), revision history (RevisionHistory), revision (Revision), branch (Branch), merge (Merge), trunk (Trunk), and symbolic revision (SymbolicRevision). Generally, in embodiments, the names of the elements may be case insensitive.

The foregoing elements are generally delimited in the body of an RSS post using tags in the form <attribute> . . . </attribute>, where the attribute specifies a name for the delimited information. Similar syntaxes may be used to parameterize this tags, such as <attribute=value>. While syntax varies for different syndication technologies, the general notion of tagging content with descriptive metadata, whether typed or untyped, appears fairly consistently across RSS, OPML, and other XML grammars. Where element names are already established by formal specification or usage convention, these existing vocabularies may be usefully employed to provide implicit or explicit structure to metadata.

For example, the contents of the clinical note element may without limitation comprise a note written by a clinician, such as a referral letter from a primary care physician to a specialist. The contents of the biochemistry result element may without limitation comprise indicia of total cholesterol, LDL cholesterol, HDL cholesterol, and/or triglycerides. The contents of the DICOM compliant MRI image element may without limitation comprise an image file in the DICOM format. The content of the keyword element may without limitation comprise a word and/or phrase associated with the content contained in the message, wherein the word and/or phrase may be processed by a Web crawler. The content of the license element may without limitation comprise a URL that may refer to a Web page containing a description of a license under which the message is available. The content of the change log element may without limitation comprise a change log. The content of the route trace element may without limitation comprise a list of the computers through which the message has passed, such as a list of “received:” headers analogous to those commonly appended to an e-mail message as it travels from sender to receiver through one or more SMTP servers. The content of the permalink element may without limitation comprise a permalink, such as an unchanging URL. The content of the time element may without limitation comprise a time, which may be represented according to RFC 868. The content of the shopping cart element may without limitation comprise a representation of a shopping cart, such as XML data that may comprise elements representative of quantity, item, item description, weight, and unit price. The content of the video element may without limitation comprise a MPEG-4 encoded video file. The content of the device element may without limitation comprise a name of a computing facility. The content of the friend element may without limitation comprise a name of a friend associated with an author of an entry. The content of the market element may without limitation comprise a name of a market. The content of the downstream processing directive element may without limitation comprise a textual string representative of a processing step, such as and without limitation “Archive This,” that ought to be carried out by a recipient of a message.

A message as described herein may include, consist of or be evaluated by one or more rules or expressions (referred to collectively in the following discussion as expressions) that provide descriptions of how a message should be processed. In this context, the message may contain data in addition to expressions or may refer to an external source for data. The expression may be asserted in a variety of syntaxes and may be executable and/or interpretable by a machine. For example, an expression may have a form such as that associated with the Lisp programming language. Although an expression may commonly be represented as what may be understood as a “Lisp-like expression” or “Lisp list”—for example, (a (b c))—this particular representation is not necessary. An expression may defined recursively and may include flow control, branching, conditional statements, loops, and any other aspects of structured, object oriented, aspect oriented, or other programming languages. For example and without limitation, it should be appreciated that information encoded as SGML or any species thereof (such as and without limitation, XML, HTML, OPML, RSS, and so forth) may easily be represented as a Lisp-like expression and vice versa. Likewise, data atoms, such as and without limitation a text string, a URL, a URI, a filename, and/or a pathname may naturally be represented as a Lisp-like expression and vice versa. Again, by way of illustration and not limitation, any representation of encoded information that can be reduced to a Lisp-like expression may be an expression as that term is used herein.

An expression may, without limitation, express the following: a data atom, a data structure, an algorithm, a style sheet, a specification, an entry, a list, an outline, a channel definition, a channel, an Internet feed, a message, metadata, a URI, a URL, a subscription, a subscription request, a network address, an indication of a network protocol, a path, a virtual path, a filename, a syntax, a syntax defining an S-expression, a set, a relation, a mathematical function (e.g., addition, subtraction, multiplication, division, exponentiation, square root, etc.), a statistical function (e.g., mean, variance, covariance, standard deviation, correlation, regression, etc.), a financial function (amortization, net present value, future value, Black-Shoales pricing, etc.), a signal processing function (Fourier transform, discrete Fourier transform, filtering (e.g., by finite or infinite impulse response filter), correlation, convolution, etc.), a matrix or array function (multiplication, reduction, etc.), a conditional statement, a loop statement, an exit condition, a cryptographic function, a graph, a tree, a counting algorithm, a probabilistic algorithm, a randomized algorithm, a geometric distribution, a binomial distribution, a heap, a heapsort algorithm, a priority queue, a quicksort algorithm, a counting sort algorithm, a radix sort algorithm, a bucket sort algorithm, a median, an order statistic, a selection algorithm, a stack, a queue, a linked list, a pointer, an object, a rooted tree, a hash table, a direct-address table, a hash function, an open addressing algorithm, a binary search tree, a binary search tree insertion algorithm, a binary search tree deletion algorithm, a randomly built binary search tree, a red-black tree, a red-black tree rotation algorithm, a red-black tree insertion algorithm, a red-black tree deletion algorithm, a dynamic order statistic, an interval tree, a dynamic programming algorithm, a matrix, a matrix-chain multiplication algorithm, a longest common subsequence, a polygon, a polygon triangulation, an optimal polygon triangulation, an optional polygon triangulation algorithm, a greedy algorithm, a Huffman code, a Huffman coding algorithm, an amortized analysis algorithm, an aggregate method algorithm, an accounting method algorithm, a potential method algorithm, a dynamic table, a b-tree, a b-tree algorithm (such as and without limitation search, create, split, insert, nonfull, delete), a binomial heap, a binomial tree, a binomial heap algorithm (such as and without limitation create, minimum, link, union, insert, extract minimum, decrease key, delete), a Fibonacci heap, a mergeable heap, a mergeable heap algorithm (such as and without limitation make heap, insert, minimum, extract minimum, and union), a disjoint set, a disjoint set algorithm, a cyclic graph, an acyclic graph, a directed graph, an undirected graph, a sparse graph, a breadth-first search algorithm, a depth-first search algorithm, a topological sort algorithm, a minimum spanning tree, a Kruskal algorithm, a Prim algorithm, a single-source shortest path, Dijkstra's algorithm, a Bellman-Ford algorithm, an all-pairs shortest path, a matrix, a matrix multiplication algorithm, the Floyd-Warshall algorithm, Johnson's algorithm, a flow network, the Ford-Fulkerson method, a maximum bipartite matching algorithm, a preflow-push algorithm, a lift-to-front algorithm, a sorting network, an arithmetic circuit, an algorithm for a parallel computer, a matrix operation, a polynomial, a fast Fourier transform, a number-theoretic algorithm, a string matching algorithm, a computational geometry algorithm, an algorithm in complexity class P, an algorithm in complexity class NP, and/or an approximation algorithm.

In one aspect, a message processor as described herein may include a hardware and/or software platform for evaluating messages according to any of the expressions described above. The message processor may reside, for example, on the server computer or client computer as described above. The processing may without limitation include the steps of read, evaluate, execute, interpret, apply, store, and/or print. The machine for processing an expression may comprise software and/or hardware. The machine may be designed to process a particular representation of an expression, such as and without limitation SGML or any species thereof. Alternatively, the machine may be a metacircular evaluator capable of processing any arbitrary representation of an S-expression as specified in a representation of an expression.

Generally, a message may include or be an expression. In other embodiments, the expression evaluation process may itself be syndicated. In such an embodiment, interpretations (i.e., evaluations) of a message may vary according to a particular evaluation expression, even where the underlying message remains constant, such as by filtering, concatenating, supplementing, sorting, or otherwise processing elements of the message or a plurality of messages. Different evaluation expressions may be made available as syndicated content using the syndication techniques described generally herein.

The message may specify presentation (e.g., display) parameters, or include expressions or other elements characterizing a conversion into one or more presentation formats.

In embodiments, the message may include an OPML file with an outline of content, such as and without limitation a table of contents; an index; a subject and associated talking points, wherein the talking points may or may not be bulleted; an image; a flowchart; a spreadsheet; a chart; a diagram; a figure; or any combination thereof. A conversion facility, which may include any of the clients or servers described above, may receive the message and convert it to a specified presentation format, which may include any proprietary or open format suitable for presentation. This may include without limitation a Microsoft PowerPoint file, a Microsoft Word file, a PDF file, an HTML file, a rich text file, or any other file comprising both a representation of content and a representation of a presentation of the content. The representation of content may comprise a sequence of text, an image, a movie clip, an audio clip, or any other embodiment of content. The representation of the presentation of the content may include characteristics such as a font, a font size, a style, an emphasis, a de-emphasis, a page-relative position, a screen-relative position, an abstract position, an orientation, a scale, a font color, a background color, a foreground color, an indication of opacity, a skin, a style, a look and feel, or any other embodiment of presentation, as well as combinations of any or all of the foregoing. In a corresponding method, a message may be received and processed, and a corresponding output file may be created, that represents a presentation format of the received message. In various aspects, the message may include an OPML file with references to external data. During processing, this data may be located and additionally processed as necessary or desired for incorporation into the output file.

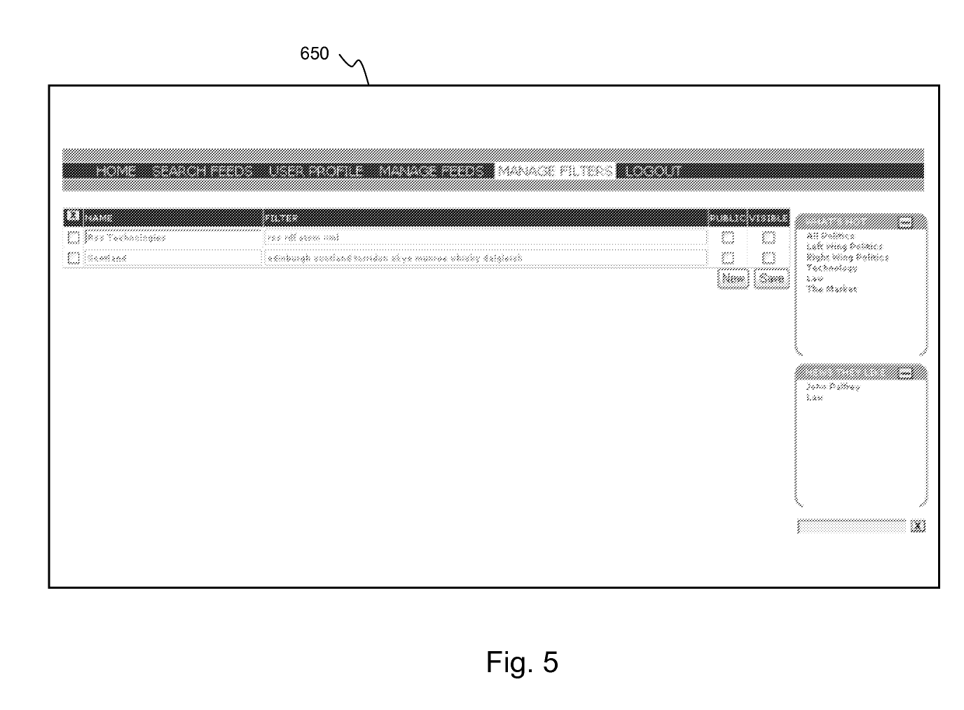

FIG. 5 shows a user interface 650 for data feed management. More particularly, FIG. 5 depicts a manage filters page in which a user can create, edit, and share filters. The page may include navigation buttons and a “What's Hot” and a “News They Like” workspace. In addition, the page may provide a list of available filters. New filters may be created, and rules for each filter may be defined using, for example, Boolean or other operators on defined fields for data feeds or on full text of items within data fields. In order to promote community activity, each filter may be made public for others to use, and the rules and other structure of each filter may also be optionally shared for others to inspect. As a significant advantage over existing systems, these filters may be applied in real time to RSS data feeds or other data feeds to narrow the universe of items that is displayed to a user.

In one aspect, the systems described herein may be used to scan historical feed data and locate relevant data feeds. For example, filters may be applied to historical feed data to identify feeds of interest to a user. For example, by searching for words such as “optical” and “surgery” in a universe of medical feeds, a user may locate feeds relevant to optical laser surgery regardless of how those feeds are labeled or characterized by other users or content providers. In another complementary application, numerous filters may be tested against known relevant feeds, with a filter selected according to the results. This process may be iterative, where a user may design a filter, test it against relevant feeds, apply to other feeds to locate new relevant feeds, and repeat. Thus, while real-time or near real time filtering is one aspect of the systems described herein, the filtering technology may be used with historical data to improve the yield of relevant material for virtually any topic of interest. Authentication-based filters may be applied. For example, a filter for content from a particular source may restrict results to content for which the source (such as an author or publisher) has been authenticated, or may use authentication as a ranking criteria, e.g., by more highly ranking content for which the source has been authenticated.

Another advantage of filtering historical data is the ability to capture transient discussions and topics that are not currently of interest. Thus, a user interested in the 1996 U.S. Presidential campaign may find little relevant material on current data feeds but may find a high amount of relevant data in the time period immediately preceding the subsequent 2000 campaign. Similarly, an arbitrary topic such as Egyptian history may have been widely discussed at some time in the past, while receiving very little attention today. The application of filters to historical feeds may provide search functionality similar to structured searching of static Web content. Thus there is disclosed herein a time or chronology oriented search tool for searching the contents of one or more sequential data feeds. Time-oriented metadata may also be authenticated. This authentication may be provided by the system as content is indexed, in which case the indexing entity serves as a trusted source of time information, or the authentication may be performed by using a remote, third party time stamping service.

In another aspect, the filters may be applied to a wide array of feeds, such as news sources, to build a real-time magazine dedicated to a particular topic. The results may be further parsed into categories by source. For example, for diabetes related filters, the results may be parsed into groups such as medical and research journals, patient commentaries, medical practitioner Weblogs, and so forth. The resulting aggregated data feed may also be combined with a readers' forum, editor's overview, highlights of current developments, and so forth, each of which may be an additional data feed for use, for example, in a Web-based, real-time, magazine or a new aggregated data feed.

In general, the filter may apply any known rules for discriminating text or other media to identified data feeds. For example, rules may be provided for determining the presence or absence of any word or groups of words. Wild card characters and word stems may also be used in filters. In addition, if-then rules or other logical collections of rules may be used. Proximity may be used in filters, where the number of words between two related words is factored into the filtering process. Weighting may be applied so that certain words, groups of words, or filter rules are applied with different weight toward the ultimate determination of whether to filter a particular item. External references from an item, e.g., links to other external content (either the existence of links, or the domain or other aspects thereof) may be used to filter incoming items of a data feed. External links to a data feed or data item may also be used, so as to determine relevance by looking at the number of users who have linked to an item. This process may be expanded to measure the relevance of each link by examining the number of additional links produced by the linking entity. In other words, if someone links to a reference and that user has no other links, this may be less relevant than someone who links to the reference and has one hundred other links. This type of linking analysis system is provided, for example, by Technorati.

Filters may apply semantic analysis to determine or approximate the tone, content, or other aspects of an item by analyzing words and word patterns therein. Filters may also examine the source of an item, such as whether it is from a .com top-level domain or an .edu top-level domain. The significance of a source designation as either increasing or decreasing the likelihood of passing through the filter may, of course, depend on the type of filter. Additionally, synonyms for search terms or criteria may be automatically generated and applied alongside user specified filter criteria.

Metadata may be used to measure relevance. Data feeds and data items may be tagged with either subject matter codes or descriptive words and phrases to indicate content. Tags may be provided by an external trusted authority, such as an editorial board, or provided by an author of each item or provider of each data feed. These and any other rules capable of expression through a user interface may be applied to items or posts in data feeds to locate content of interest to a particular user. Metadata may be authenticated in a variety of manners. For example, a content source may authenticate its own content, either as a certificate authority or by reference to a trusted third party. Similarly, post-publication metadata may be added to content, either through automated analysis, social networking (e.g., by categorization, keyword tagging, popularity, ranking, etc.), or direct manual content tagging. This metadata may also be authenticated, such as by a computer or user that added the metadata.

As noted above, a user may also share data feeds, aggregated data feeds, and/or filters with others. Thus, in general, there is provided herein a real-time data mining method for use with data feeds such as RSS feeds. Through the intelligent filtering enabled by this data feed management system, automatically updating information montages tailored to specific topics or users may be created that include any number of different perspectives from one to one hundred to one thousand or more. These real-time montages may be adapted to any number of distinct customer segments of any size, as well as to business vertical market applications.

In another aspect, filters may provide a gating technology for subsequent action. For example, when a number of items are identified meeting a particular filter criterion, specific, automated actions may be taken in response. For example, filter results, or some predetermined number of filter results, may trigger a responsive action such as displaying an alert on a user's monitor, posting the results on a Weblog, e-mailing the results to others, tagging the results with certain metadata, or signaling for user intervention to review the results and status. Thus, for example, when a filter produces four results, an e-mail containing the results may be transmitted to a user with embedded links to the source material.

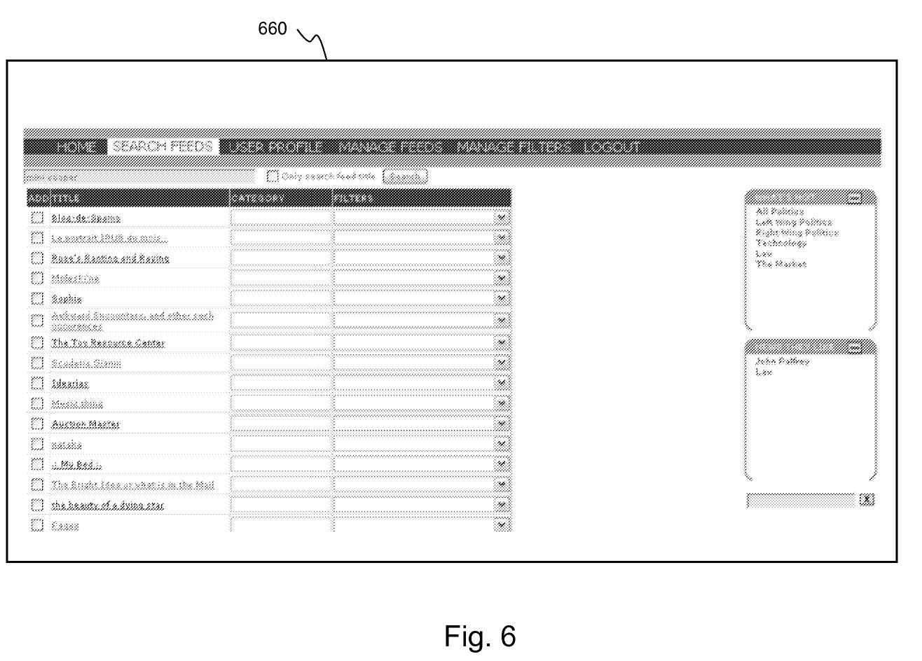

FIG. 6 shows a user interface 660 for data feed management. More particularly, FIG. 6 depicts a search feeds page in which a user can search for additional data feeds to monitor. The page may include navigation buttons and a “What's Hot” and a “News They Like” workspace. In addition, the page may include a text input field for user input of one or more search terms. There may also be one or more checkboxes or other controls for additional search parameters. For example, a user may select whether to search titles only, other information in the description of the feed, or individual items or postings in the feed. The search itself may also be stored, so that new searches for the same subject matter optionally will not include feeds that a user has already reviewed and rejected. Alternatively, the search may be persistent, so that the request search continues to execute against a database of feeds and posts as new feeds and new posts are added. Thus a user may leave the search and return to the search at a later time to review changes in results. The results for a search may be presented in the user interface along with a number of user controls for appropriately placing the feed within the user's feed environment. For example, a user may provide a new, user-assigned category to a feed or select from one or more of the user's pre-existing categories. The user may also specify one or more filters, either pre-built or custom-built by the user, to apply to items in the data feed once it is added. After a feed has been added, the user may review items passing through the assigned filter, if any, in the home page discussed above.

It will be appreciated that search results will be improved by the availability of well organized databases. While a number of Weblogs provide local search functionality, and a number of aggregator services provide lists of available data feeds, there does not presently exist a consumer-level searchable database of feed contents, at least nothing equivalent to what Google or Altavista provide for the Web. As such, one aspect of the system described herein is a database of data feeds that is searchable by contents as well as metadata such as title and description. In a server used with the systems described herein, the entire universe of known data feeds may be hashed or otherwise organized into searchable form in real time or near real time. The hash index may include each word or other symbol and any data necessary to locate it in a stream and in a post.

One useful parameter that may be included for searching is age. That is, the age of a feed, the age of posts within a feed, and any other frequency data may be integrated into the database for use in structured user searches (and the filters discussed in reference to FIG. 5). Another useful parameter may be authentication status. For example, applying the authentication techniques described herein, an authentication status may be assigned to any item of metadata. This includes, for example, not authenticated, which would indicate that either authentication is unavailable, or that an authentication attempt failed. Other status types may include authenticated by a search engine, authenticated by the source, authenticated by the author, and so forth.

As a further advantage, data may be retrieved from other aggregators and data feeds on a well-defined schedule. In addition to providing a very current view of data streams, this approach prevents certain inconsistencies that occur with currently used aggregators. For example, even for aggregator sites that push notification of updates to subscribers, there may be inconsistencies between source data and data feed data if the source data is modified. While it is possible to renew notification when source material is updated, this is not universally implemented in aggregators or Weblog software commonly employed by end users. Thus an aggregator may extract data from another aggregator that has not been updated. At the same time, an aggregator or data source may prevent repeated access from the same location (e.g., IP address). By accessing all of this data on a regular schedule (that is acceptable to the respective data sources and aggregators) and storing the results locally, the server described herein may maintain a current and accurate view of data feeds. Additionally, feeds may be automatically added by searching and monitoring in real time, in a manner analogous to Web bots used by search engines for static content.

In another aspect, a method of selling data feed services is disclosed herein. In this method, RSS data which is actually static content in files may be serialized for distribution according to some time base or time standard such as one item every sixty seconds or every five minutes. In addition, data may be filtered to select one item of highest priority at each transmission interval. In another configuration, one update of all items may be pushed to subscribers every hour or on some other schedule in an effective batch mode. Optionally, a protocol may be established between the server and clients that provides real time notification of new items. A revenue model may be constructed around the serialized data in which users pay increasing subscription rates for increasing timeliness, with premium subscribers receiving nearly instantaneous updates. Thus in one aspect, a data feed system is modified to provide time-based data feeds to end users. This may be particularly useful for time sensitive information such as sports scores or stock prices. In another embodiment, the end-user feed may adhere to an RSS or other data feed standard but nonetheless use a tightly controlled feed schedule that is known to both the source and recipient of the data to create a virtual time based data feed.

Other interfaces may similarly be provided for various aspects of data feed or OPML discovery, management, filtering, aggregation, and so forth. In addition, a system for managing content as described herein may provide a variety of value-added services using the infrastructure described above. All such variations are intended to fall within the scope of this disclosure.

A number of enhanced syndication systems providing security are now described in greater detail. While a number of examples of RSS are provided as embodiments of a secure syndication system, it will be appreciated that RDF, Atom, or any other syndication language, or OPML or other structured grammar may be advantageously employed within a secure syndication framework as set forth herein.

Security may impact a number of features of a syndication system. For example, a data stream system may use identity assignment and/or encryption and/or identity authentication and/or decryption by public and private encryption keys for RSS items and similar structured data sets and data streams. The system may include notification of delivery as well as interpretation of delivery success, failure, notification of possible compromise of the end-to-end security system, non-repudiation, and so on. The identity assignment and encryption as well as the authentication and decryption as well as the notification and interpretation may occur at any or multiple points in the electronic communication process, some of which are illustrated and described below. A secure RSS system may be advantageously employed in a number of areas including, but not limited to, general business, health care, and financial services. Encryption may be employed in a number of ways within an RSS system, including encryption and/or authentication of the primary message, notification to a sender or third party of receipt of messages, interpretation of delivery method, and processing of an RSS item during delivery.

In item-level encryption of the primary message, an item from an RSS source or similar source may be assigned an identifier (which may be secure, such as a digital signature) and/or encrypted with a key (such as a private key in a Public Key Infrastructure (PKI)) and transmitted to a recipient, who may use a corresponding public key associated with a particular source to authenticate or decrypt the communication. A public key may be sent to the recipient simultaneously or in advance by a third party or collected by the recipient from a third-party source such as a public network location provided by the source or a trusted third party. In other embodiments, an intended recipient may provide a public key to a sender, so that the sender (which may be a content source, aggregator, or other RSS participant) may encrypt data in a manner that may only be decrypted by the intended recipient. In this type of exchange, the intended recipient's public key may similarly be published to a public web location, e-mailed directly from the recipient, or provided by a trusted third party.

In tag-level encryption of fields of data delimited within a message, similar encryption techniques may be employed. By using tag-level encryption, security may be controlled for specific elements of a message and may vary from field to field within a single message. Tag-level encryption may be usefully employed, for example, within a medical records context. In a medical environment (and in numerous other environments), it may be appropriate to treat different components of, e.g., a medical record, in different ways. Thus, while a medical record of an event may include information from numerous sources, it may be useful to compose the medical record from various atomic data types, each having unique security and other characteristics associated with its source. Thus, the medical record may include treatment objects, device objects, radiology objects, people objects, billing objects, insurance objects, diagnosis objects, and so forth. Each object may carry its own encryption keys and/or security features so that the entire medical record may be composed and distributed without regard to security for individual elements.

In a notification system, a secondary or meta return message may be triggered by receipt, authentication, and/or decryption of the primary message by a recipient and sent by the recipient to the message originator, or to a third party, to provide reliable notification of receipt.

In interpretation of delivery information, a sender or trusted intermediary may monitor the return message(s) and compare these with a list of expected return messages (based for example on the list of previously or recently sent messages). This comparison information may be interpreted to provide information as to whether a communication was successful and, in the case of communication to more than one recipient, to determine how many and what percentage of communications were successful. The receipt of return messages that do not match the list of expected messages may be used to determine that fraudulent messages are being sent to recipients, perhaps using a duplicate of an authentic private key, and that the security service may have been compromised.

In another aspect, a series of encryption keys may be used by the source and various aggregators or other intermediaries in order to track distribution of items through an RSS network. This tracking may either use notification and interpretation as described herein or may simply reside in the finally distributed item, which will require a specific order of keys to properly decrypt some or all of the item. If this system is being used primarily for tracking, rather than security, encryption and decryption information may be embedded directly into the RSS item, either in one of the current fields or in a new field for carrying distribution channel information (e.g., <DISTRIBUTION> . . . </DISTRIBUTION>.

In another aspect, the message may be processed at any point during distribution. For example, the communication process may include many stages of processing from the initial generation of a message through its ultimate receipt. Any two or more stages may be engaged in identity assignment and/or encryption as well as the authentication and/or decryption as well as notification and/or interpretation. These stages may include but are not limited to message generation software such as word-processors or blog software, message conversion software for producing an RSS version of a message and putting it into a file open to the Internet, relay by a messaging service such as one that might host message generation and RSS conversion software for many producers, relay by a proxy server or other caching server, relay by a notification server whose major function is notifying potential recipients to “pull” a message from a source, and services for message receiving and aggregating and filtering multiple messages, message display to recipients, and message forwarding to further recipients.

In another aspect, a message may include one or more digital signatures, which may be authenticated with reference to, for example, the message contents, or a hash or other digest thereof, in combination with a public key for the purported author. Conversely, a recipient of a digitally signed item may verify authenticity with reference to the message contents, or a hash or other digest version thereof, in combination with a private key of the recipient. Thus it will be apparent that encryption, signature, authentication, conditional access, and other applications of cryptographic technologies may be usefully combined with the methods and systems described herein in a variety of ways. In one aspect discussed in greater detail below, certificate-based technologies may be employed to authenticate all or some of the content indexed by a searchable database.

Certificates may be employed to improve searching and presentation of results. Generally, a certificate authority issues certificates for use by other entities. The certificate authority, which may be a commercial entity such as VeriSign, Entrust or any of a number of other third party certificate authorities that provides certificate-related services for a fee, or any other institution, government authority, or other trusted third party, may be employed in a number of well-known ways to provide security, authentication, conditional access, or any other cryptography-based or similar services such as key distribution and digital signatures. Certificates may be managed, for example, using the security or infrastructure services described above.

In general certificate-based technologies apply cryptographic technologies to build trust relationships upon verified credentials. A number of techniques are known for authentication including asymmetric key pairs in a public key infrastructure. However, other techniques such as a web of trust using PGP or the like may also be employed. In some embodiments, a commercial vendor such as VeriSign may operate as a trusted third party issuing certificates. In other embodiments, a search engine may itself operate as a certificate authority, although the trustworthiness of certificates so issued will necessarily depend on trustworthiness of the certificate authority. At the same time, a variety of encryption types of various strengths are known in the art, many of which may be used by a certificate authority. In the following discussion, the details of various authentication protocols, encryption technologies, and the like will be avoided in order to focus on the functional cooperation of various participants in certificate-based methods. However, it will be appreciated that numerous suitable encryption technologies are available, which may be used alone or in combination with one another in the following embodiments.

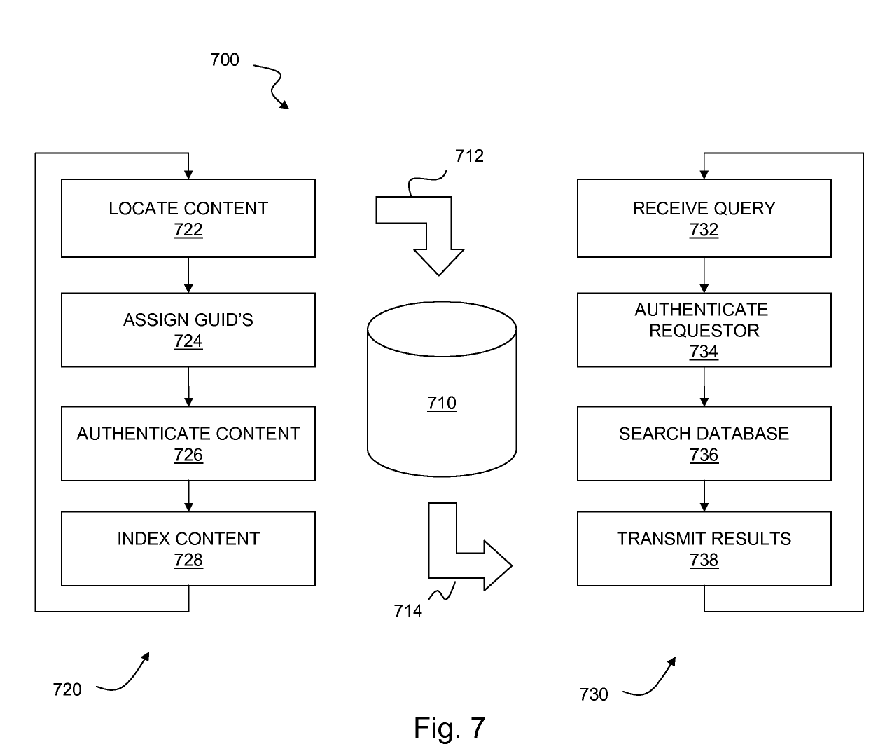

FIG. 7 depicts a generic process for certificate-based search. In general, the process 700 operates to store located content in a searchable database 710, as indicated by arrow 712, and to provide the content in response to queries, as indicated by arrow 714.

A content discovery process 720 may begin by locating content as shown in step 722. This may include a variety of techniques including spidering, link analysis, and so forth. In one aspect, the discovery process 720 may be dedicated to a specific content type. For example, an OPML search engine may focus exclusively on OPML content, traversing OPML outlines (including external references) and indexing other documents only when they appear on a leaf node of an OPML outline. An RSS search engine may focus exclusively on RSS syndicated content, along with enclosures and the like. In an RSS search engine, each new RSS post may be analyzed to identify additional channels for searching. More generally, content location 722 may be directed at any web-accessible or other network accessible content. The location, referred to below as a path, uniquely identifies a location of the located content within the search domain. In a local area network, this may include file system path information such as a drive and folder specification. In a wide area network this may include an IP address, a URL, and any other useful information for identifying a location and, where appropriate, a resource for accessing the content at that location. All such conventions for uniquely identifying a location on a network may be employed as a path as that term is used herein. While an Internet-scale search engine is one possible embodiment, it will be appreciated that search engines may usefully be employed within other content domains, such as a website, a top-level domain, an enterprise area network, a local area network, or an individual computer. All such embodiments are intended to fall within the scope of this disclosure.

When a new item of content is located, the process 720 may proceed to step 724 where a globally unique identifier is assigned to the content. In one aspect, the process 720 may first determine whether a new content item (referred to generally below as a “document”) is unique. In certain embodiments, it may be helpful to determine whether a document already exists in the search engine database 710. Where a document is unique the search engine may associate a new globally unique identifier with the document for purposes of identification. When the document is non-unique, the process 720 may identify the document as an instance of a document. In other embodiments, all newly identified documents may be assumed unique.

To provide further granularity to search results, individual elements (also referred to herein as “fragments”) of a document may each be assigned a globally unique identifier. This permits content addressing at the level of individual elements, lines of XML code, items of metadata, or other sub-components of a document. For example, in an OPML document, a globally unique identifier may be assigned to each list element within the outline. Where OPML is used for functional descriptions as described above, this indexing technique permits access to particular functional units within an OPML outline. For an RSS document, a globally unique identifier may be assigned to each item of text content, as well as each item of metadata, each enclosure, and so forth. More generally, any XML document may be accessed on a line-by-line, tag-by-tag, or other basis. For example, globally unique identifiers may be provided for each tag-delimited item of metadata within an OPML outline, an RSS channel, or an RSS item, or more generally for any tag-delimited content within an XML document. Where individual tags are identified, content may be hierarchically parsed according to the tag content. For example, a tag may identify an attribute type such as time, source, title, keyword, or the like, with the attribute value delimited by the corresponding tags.

As noted below, the globally unique identifier(s) may be stored in conjunction with the location (i.e., path or path information) to permit granular remote access to content. In one aspect, a technology such as xpointer may be employed for navigation to locations within a network-accessible document. The xpointer address may be stored along with the globally unique identifier in the database 710. In this step, additional analysis such as tag analysis or semantic analysis may be applied to provide a computer-generated description of the item identified by the globally unique identifier. Further, these techniques may be combined during parsing of a new document. For example, introductory tags may be labeled according to explicit tag information such as a source, an author, or the like. Content such as the text of an RSS post may be semantically analyzed for content, or a description may simply characterize the content as “content” or the like. A composite document may subsequently be formed by concatenating or otherwise using a number of globally unique identifiers, which may in turn be interpreted during parsing of the composite document by referencing the identifiers in the database 710 and retrieving corresponding content (either from the database 710 or from the path and internal location identified in the database 710).

As shown in step 726, the content may be authenticated. This may include a variety of authentication techniques for authenticating or verifying the content or portions thereof. In one aspect, the system operating the search engine may self-certify content, thus acting as a certificate authority to other clients requesting search results therefrom. In one embodiment, the search engine may sign a certificate with a private key for each item of content and publish a corresponding public key to permit verification of the search engine's signature to third parties. While this system works well provided clients do, in fact, trust the search engine, it does not provide any further certification of the indexed content in the database 710 that might otherwise be useful beyond what the search engine can provide. In order to support a broader level of trust, the search engine may securely distribute private keys (with any appropriate form of authorization such as personal credentials, physical signatures, notarization, or the like from the key recipient) to content sources. The content sources may use the private key to digitally sign published content, and the search engine may, through use of the corresponding public key, verify that the content belongs to the source. This system may also work well, although it does not guard against theft or other mis-distribution of private keys. In another embodiment, authentication may be performed with reference to a trusted third party such as VeriSign, which may act as a certificate authority for content sources. In such cases, the search engine may, for example, receive a certificate with the content and verify the certificate with a public key obtained through the trusted third party or the content source. The search engine may also, or instead, directly decrypt located content with an associated public key. Other credential-oriented techniques are also known and may be employed in direct and/or indirect communications between various content sources, trusted third parties, and the search engine that is authenticating data.

However determined, the search engine's authentication process results in authentication status for each item of content. This may include an indication that the item is unauthenticated, unauthenticatable, authenticated by the search engine, authenticated by the content source, authenticated by a trusted third party, authenticated across a distribution channel, authenticated by a distribution intermediary, and so forth. In syndication networks, one item of interest is the content source, which may be a publisher, an author, a corporate entity, an organization, a news media source, a syndication feed, an aggregator, a republisher, or some other entity in a distribution channel. The source may specify an original source of the document, the source from which the document was located/retrieved, or the entire chain of distribution for the document. Where the document is retrieved from a location other than the original source, inspection of the metadata and source authentication may be particularly helpful. The source may also refer to a top level domain or other source that is defined with reference to network addresses, topology, namespaces, paths, or the like.

It will be understood that, as with globally unique identifiers above, authentication may be provided for an element or fragment of a document. For example, a content source may be authenticated without authenticating an author, or a time of publication may be authenticated without authenticating a content source. In addition, metadata added in tags after initial distribution, such as by a metadata enrichment engine, a social networking system, or a semantic analysis engine, may be authenticated with respect to the individual or system that added the tag, but not with respect to other items such as the content source. Metadata that might usefully be authenticated (e.g., where source verification may be helpful) includes a preference, a content description, a ranking, a relevance, a keyword, an author, a publisher, a related concept, an approval, a disapproval, a popularity, a number of views, a number of links to the item, and a message type. More generally, metadata may be any objective or subjective metric for the content or its evaluation by readers. The metadata may be computer-generated, human-generated, or human-selected (e.g., as one of a number of valid values for an attribute).

Once content has been authentication the system may index the content and store the content in the database 710 as shown in step 728. In general, this includes storing a location or path of the content, any internal reference information for fragments, any globally unique identifiers, and some or all of the content. The content may be indexed by individual words, metadata, or any other suitable techniques known for storing data in a search engine database. The database 710 may store an entire instance of the content, portions of the content useful for searching, or a reference to the remotely located content, or some combination of these. In addition, the content and other data may be encrypted before storage. This permits conditional access to the data based upon requestor authentication as described below.

The database 710 may be any suitable database such as a relational database, an XML database or any other database system suitable for the uses described herein. The database may be a secure database that provides conditional access and/or encrypts database contents for security or conditional access as described herein.

A process for using the search engine 730 may begin when a query is received as shown in step 732. This query may be submitted through an application programming interface, a web-based interface, or any other suitable interface. In general, the query may include keywords and any other suitable search parameters such as exclusions, search domains, content types, and so forth. In one aspect, the web-accessible interface may permit use of content source or author as a search parameter.

In some embodiments, the requestor may be authenticated as shown in step 734. This authentication may employ any of the techniques described herein, generally including authentication directly by the search engine system and authentication with reference to a trusted third party. Authentication of the requester may be used in a number of useful ways. In one aspect, the requestor's authentication may be used to provide conditional access to some or all of the records in the database 710 so that different search results may be provided according to a requestor's access rights. Access may be role based, so that different users have access to different data according to role. Role-based access may be enforced by conditionally granting access to the search engine, by restricting the release of search results, or by encrypting database content and provide decryption keys in conjunction with assignment of roles. In another aspect, all content in the database 710 may be publicly available, but certain data may be encrypted so that the results will only be meaningful when decrypted using a requestor's private key. In another aspect, conditional access may be assigned according to semantic content of results. Thus for example, certain roles may have access to certain types of data while other roles may have access to different types of data. The semantic content may be inferred from metadata, inferred from authenticated, inferred from content analysis by the search engine, or otherwise determined. In another aspect, certain authenticated users may have an ability to write data to the database 710, either as a content source or as a spider or other autonomous search agent that periodically provides results to the database 710. Authentication may be explicit, e.g., through a dialogue with the requester, or implicit, such as through use of a cookie or other client-side technique for communicating credentials to the database 710.

Once a requestor has been authenticated, the process 730 may proceed to search the database as shown in step 736. This may employ any query or search techniques suitable for the database technology employed by the database 710, and may either directly parse and apply the query received in step 732, or may process the query using any number of know techniques to infer the intent of the requestor's search.

Results of the search may be transmitted to the requestor as shown in step 738. This may include ranking results in a number of ways. In one aspect, results may be ranked or filtered according to authentication. For example, authenticated results may be given preferential ranking to non-authenticated results. Or, specific types of authentication may be specified for ranking. For example, authenticated content source may be given a preferred ranking, or authenticated time of publication. In another aspect, where a query specifies one or more keywords, only results with corresponding authenticated metadata may be returned as results, or these results may be ranked more highly than other results. Where an authentication status is provided by the location process 720, the authentication status may be used as a ranking criterion so that authenticated content is preferentially listed.

It will be appreciate that, while shown as single, linear processes, the steps may be varied, such as by authenticating before assigning globally unique identifiers, and that any number of concurrent processes may be operating so that large quantities of data can be indexed concurrently where appropriate. While a generalized system for certificate-based indexing and search has been described above, a number of specific implementations built on the process of FIG. 7 are now described in greater detail.

In one aspect, the search resource (e.g., a search engine or spidering resource) may, itself, operate as a certificate authority. The search resource may usefully employ certificates in a number of ways. For example, the search resource may issue certificates for publication at content locations. The certificate may certify one or more features of a content location. For example, the search resource may acknowledge an owner, editor, or manager of content at the location. Or the search resource may certify sources of content at the location, such as authors, organizations, or the like. The search resource may certify a creation or modification date of content at the location, or other content or source file status. The search resource may certify metadata associated with the location, or content stored therein. Still more generally, any status, description, or other characteristic, content, or information may be certified by the search resource in its capacity as a certificate authority, and a corresponding certificate may be created and/or distributed as appropriate. In one aspect, certificates may be distributed directly to the content locations upon certification. The certificate may, in turn, be published at the content location or otherwise made available for public use. In this case, other search resources, search facilities, or users may obtain the certificate and (either directly, or by reference to the certificate authority) process content and search results from the location accordingly. For example, a search may be conducted for written works by an author. Potential search results may be filtered to return only those results containing a certificate asserting the desired authorship. Other certificate-based searches may similarly be constructed at different levels of abstraction. For example, a search may be restricted to results bearing a certificate that identifies an author, regardless of the author, or a certificate that identifies a source (such as a newspaper or publisher), or any other type of certificate. Or a search may be restricted to results bearing a certificate that identifies a creation date, and so forth.

As another example, the search resource may act as a trusted third party by responding to requests from other entities accessing content at the location. In this context, the search resource may store characteristics of remote content, which may have been automatically created or identified characteristics using, e.g., any objective criteria, or manually provided or generated by human agents of the search resource who review the location and content and/or metadata therein to provide characterizations amenable to certification.

As another example, the search resource may distribute certificates to users. In this manner, the search resource may operate as a key management infrastructure that controls access to indexes within the search engine. Thus, conditional access may be enforced for users of the search engine by authenticating search requests. Permissions may be flexibly managed using known techniques to permit, e.g., a grant of permission from one entity to another entity for limited access to specific data. Through this infrastructure, permission to write to certain locations, read from certain locations, use certain spider or other search capabilities, and the like may be controlled at the search resource according to user identity. Similarly, a user may embed within a request, or receive from the search resource according to identity, one or more keys to decrypt content at locations specified by a search. Thus, pools of secure data may be maintained using a certificate-based search resource as a front end to one or more data sources. In one architectural implementation, certain content may be accessible exclusively through the search resource, so that the search resource also acts as a secure data repository according to user access privileges.

As another example, the search resource may generate certificates as it locates and indexes content. Certificates may be generated according to semantic or other rules, and may be indexed along with search results to provide certificate-based searching locally at the search resource. In another embodiment, search results may be encrypted as they are indexed, with access to particular results managed based upon roles, identities, or other schemes for conditional access.

In another distributed embodiment, a location may act as a certificate authority for content within its domain. Thus each item of content may be certified with respect to one or more characteristics, with one or more corresponding certificates attached to, embedded in, or included with metadata for the content. A search engine or other search resource may index or otherwise process results according to location-provided certificates, and may independently assess related matters such as the existence of location-provided certificates and the reliability of location-provided certificates. Using various trust-based services and techniques, the system may be further improved by enabling locations to receive delegated certificate authority from a trusted third party, or to otherwise issue certificates (such as by acquiring certificates in bulk for reuse) that provide reliability with reference to a trusted third party other than the location.

A number of certificate-based technologies are known and may be usefully employed with certificate-based search as described herein. For example, Public Key Infrastructure (using asymmetric public/private key pairs) and Kerberos (using symmetric cryptography) rely on a trusted third party. Other approaches such as Pretty Good Privacy and the like provide an alternative to a centralized infrastructure, while providing similar authentication or other trust-based services. Commercial providers of certificates and third-party certificate authority services that may be employed with the systems described herein include, for example, Comodo, Digicert, Digi-Sign, Digital Signature Trust Co., Ebizid, Enterprise SSL, Entrust, EuroTrust A/S, GeoTrust, GlobalSign, LiteSSL, Network Solutions SSL Certificates, Power 4 SSL, QualitySSL, Secure SSL, SpaceReg, SSL.com, Thawte Digital Certificates, VeriSign, and XRamp Security.

It will be understood that the incorporation of a trusted third-party provider of digital certificates into the foregoing systems, and more generally into an enhanced syndication infrastructure, may serve as a platform for numerous additional features and services, some of which are described above, including non-repudiation, authentication, conditional access, security, and so forth.

The above methods and systems may be realized in hardware, software, or any combination of these suitable for the search engine applications described herein. This includes realization in one or more microprocessors, microcontrollers, embedded microcontrollers, programmable digital signal processors or other programmable devices, along with internal and/or external memory. The may also, or instead, include one or more application specific integrated circuits, programmable gate arrays, programmable array logic components, or any other device or devices that may be configured to process electronic signals. It will further be appreciated that a realization may include computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as a database system, a web server, and so forth in a number of ways or all of the functionality may be integrated into a dedicated, standalone device. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention as claimed below is not to be limited by the foregoing examples, but is to be understood in the broadest sense allowable by law.

1. A method for indexing online content comprising:
retrieving a document from a remote network location, the remote network location identified by a path;
identifying a fragment in the document;
assigning a globally unique identifier to the fragment; and
storing the path, the globally unique identifier, and at least a portion of the fragment in a searchable database.

2. The method of claim 1 wherein the document is an outline document.

3. The method of claim 2 wherein the fragment is an element of the outline document.

4. The method of claim 1 wherein the document is a syndicated document.

5. The method of claim 4 wherein the fragment is an item of the syndicated document.

6. The method of claim 1 wherein the document is an XML document.

7. The method of claim 1 wherein the fragment is a line of the document.

8. The method of claim 1 wherein the fragment is an item within the document, the item delimited within the document by one or more tags.

9. The method of claim 8 wherein the one or more tags specify one or more attributes of the item.

10. The method of claim 1 wherein the fragment is a metadata tag.

11. The method of claim 1 further comprising determining a description of the fragment and associating the description with the globally unique identifier.

12. The method of claim 1 further comprising certifying the globally unique identifier.

13. The method of claim 1 further comprising forming a composite document from a plurality of globally unique identifiers.

14. The method of claim 13 further comprising parsing the composite document by applying one of the plurality of globally unique identifiers to the database to retrieve a corresponding path and retrieving a corresponding fragment from a corresponding remote network location specified by the corresponding path.

15. The method of claim 1 determining whether the fragment has been indexed in the searchable database and conditionally assigning the globally unique identifier only when the fragment has not been indexed.

16. The method of claim 15 wherein when the fragment has been indexed, identifying the fragment in the document as a new instance of the fragment identified by the globally unique identifier.

17-32. (canceled)

33. A method for certifying content of a searchable database comprising:
locating an item of content on a network, the item having a path that identifies a location of the item on the network;
determining an attribute of the item, the attribute having an attribute type;
creating a public key and a private key for the attribute type;
creating a certificate comprising at least the public key, the attribute type, the attribute and a digital signature created using the private key;
storing the certificate, the attribute, and at least a portion of the item in a database; and
providing a web-accessible search engine for searching the database, the web-accessible search engine permitting searching according to the attribute.

34. The method of claim 33 wherein the attribute type is a time that the item was located.

35. The method of claim 33 wherein the attribute type is a source of the item.

36. The method of claim 35 wherein the source includes one or more of a domain, a corporate entity, an organization, and an author.

37. The method of claim 33 wherein determining the attribute includes confirming the path and using the path as the attribute.

38. The method of claim 33 wherein the web-accessible search engine ranks search results according to the attribute.

39. The method of claim 33 further comprising authenticating the attribute by applying the public key to the digital signature.

40-46. (canceled)

47. A method for certifying content of a searchable database comprising:
creating a public and a private key for a content source;
securely communicating the private key to the content source;
retrieving an item of content from the content source;
verifying the content source with the public key; and
indexing the item in a database along with an entry indicating a verification of the content source; and
providing a web-accessible search engine for searching the database, the web-accessible search engine permitting searching according to the content source.

48. The method of claim 47 wherein verifying the content source includes decrypting a certificate associated with the item.

49. The method of claim 47 wherein verifying the content source includes decrypting the item.

50. The method of claim 47 wherein the content source is one or more of a corporate entity, an author, and a news media source.

51-52. (canceled)

53. The method of claim 47 wherein retrieving the item includes locating the item with a spider.

54. The method of claim 47 wherein the item is an RSS item or an OPML outline.

55. (canceled)

56. The method of claim 47 wherein retrieving the item of content includes retrieving the item indirectly through a syndication channel and identifying the content source by inspecting metadata for the item of content.

57-66. (canceled)

67. A method for operating a search engine comprising:
retrieving an item of content from a network;
encrypting the item;
indexing the item in a database;
distributing keys to a plurality of users; and
providing a web-accessible search engine for the database, the search engine authenticating a user for each search request according to the keys.

68. The method of claim 67 further comprising providing unauthenticated access to a portion of the database.

69. The method of claim 67 further comprising providing role-based access to the plurality of users.

70. The method of claim 69 wherein at least one role can read all the database locations.

71. The method of claim 69 wherein at least one role can write to at least one database location.

72. The method of claim 69 wherein at least one role can control a programmable spider that searches the network for content.

73. The method of claim 69 wherein at least one role has conditional access according to semantic content.

74. The method of claim 69 wherein at least one of the plurality of users is a spider having write access to the database.

75-82. (canceled)

83. A method for certifying content of a searchable database comprising:
retrieving an item of content from a content source;
retrieving a public key of the content source;
verifying the content source with the public key;
indexing the item in a database along with an entry indicating a verification of the content source; and
providing a web-accessible search engine for searching the database, the web-accessible search engine permitting searching according to the content source.

84. The method of claim 83 wherein verifying the content source includes decrypting a certificate associated with the item.

85. The method of claim 83 wherein verifying the content source includes decrypting the item.

86-88. (canceled)

89. The method of claim 83 wherein retrieving the item includes locating the item with a spider.

90. The method of claim 83 wherein the item is an RSS item.

91. The method of claim 83 wherein the item is an OPML outline.

92. The method of claim 83 wherein retrieving the item of content includes retrieving the item indirectly through a syndication channel and identifying the content source by inspecting metadata for the item of content.

93-102. (canceled)

103. A method for operating a search engine comprising:
locating one or more documents on a network;
indexing the one or more documents in a database;
authenticating a source for each of the one or more documents thereby providing an authentication status; and
providing a web interface for searching the database, the web interface adapted to rank search results according to the authentication status.

104. The method of claim 103 the web interface further adapted to filter search results to remove any of the one or more documents for which the authentication status is unauthenticated.

105. The method of claim 103 wherein the authentication status includes one or more of unauthenticated, authenticated by the content source, authenticated by the search engine, and authenticated by a trusted third party.

106. The method of claim 103 wherein the source includes one or more of an author, a news media source, and a publisher.

107. The method of claim 103 wherein the source includes a corporate entity.

108-112. (canceled)

113. A method for operating a search engine comprising:
locating a document on a network, the document including a metadata attribute delimited by one or more tags;
indexing the document in a database;
determining a source of the metadata attribute;
authenticating the source thereby providing an authentication status; and
providing a web interface for searching the database, the web interface adapted to rank search results according to the authentication status.

114. The method of claim 113 wherein authenticating the source includes processing a certificate associated with the metadata attribute.

115. The method of claim 114 wherein the certificate was provided by the source.

116. The method of claim 114 wherein the certificate was provided by a trusted intermediary that authenticated the source.

117. The method of claim 113 wherein authenticating the source includes requesting authentication from a trusted third party.

118. The method of claim 113 wherein authenticating the source includes requesting authentication from the source.

119. The method of claim 113 wherein authenticating the source includes requesting authentication from a trusted intermediary that has authenticated the source.

120-150. (canceled)
